(19) United States
(12) Patent Application Publication
(10) Pub. No.: US 2026/0289137 A1
(43) Pub. Date: Sep. 24, 2026

(54) SYSTEM

(71) Applicant: SoftBank Group Corp., Tokyo (JP)

(72) Inventor: Shunji IIDA, Tokyo (JP)

(73) Assignee: SoftBank Group Corp., Tokyo (JP)

(21) Appl. No.: 19/565,573

(22) Filed: Mar. 13, 2026

(30) Foreign Application Priority Data
Mar. 19, 2025 (JP) 2025-045030

(51) Int. Cl. G06F 40/30; G06F 40/253; G06F 40/268

(52) U.S. Cl. CPC G06F 40/30; G06F 40/253; G06F 40/268

(57) ABSTRACT

A system includes a processor that is configured to acquire inquiry content from a user as text data by using a natural language processing technique, perform morphological analysis and grammatical analysis on the acquired text data, and convert the acquired text data into structured data, generate a prompt sentence on the basis of the analyzed structured data in order to instruct a generative artificial intelligence model to generate a specific response, and input the generated prompt sentence into the generative artificial intelligence model.

### CROSS-REFERENCE TO RELATED APPLICATION

This application is based on and claims priority under 35 USC 119 from Japanese Patent Application No. 2025-045030 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional customer support systems and dialog systems often rely on rule-based processing or simple pattern matching to handle user inquiries. As a result, such systems have difficulty understanding complex or ambiguous natural language expressions contained in user inquiries, and thus fail to accurately capture the intent, context, or nuances of the user. Furthermore, in systems that utilize generative artificial intelligence models, prompt sentences for instructing the models are frequently created in a fixed or manually defined manner, without sufficiently reflecting the detailed structure, extracted keywords, or contextual relationships present in the user's inquiry text. This leads to problems such as inappropriate or irrelevant responses, low response accuracy, and a lack of real-time adaptability to diverse user inputs. In addition, even when an appropriate response is generated by the generative artificial intelligence model, there is a need for a mechanism that can deliver such a response promptly and in real time as a text message to the user terminal. Therefore, there is a demand for a system that can precisely analyze inquiry content from a user by natural language processing, automatically generate an optimal prompt sentence based on structured analysis results, cause a generative artificial intelligence model to generate an appropriate response, and provide the generated response to the user in real time.

### SUMMARY

In order to solve the above-described problems, according to one aspect of the present invention, there is provided a system comprising a processor, wherein the processor is configured to acquire inquiry content from a user as text data by using a natural language processing technique, perform morphological analysis and grammatical analysis on the acquired text data, and convert the acquired text data into structured data. The processor is further configured to generate a prompt sentence on the basis of the analyzed structured data in order to instruct a generative artificial intelligence model to generate a specific response, and to input the generated prompt sentence into the generative artificial intelligence model. The processor may be configured to extract related keywords and context on the basis of the inquiry content from the user, and construct the prompt sentence on the basis of the extracted related keywords and context, thereby enabling the generative artificial intelligence model to generate a response that more accurately reflects the user's intent and situation. In addition, the processor may be configured to transmit a generated natural language response as a text message to a terminal of the user in real time. By such configurations, the system can perform detailed analysis of user inquiry content, generate an appropriate prompt sentence for a generative artificial intelligence model, obtain a suitable natural language response, and provide the response promptly to the user.

The term “processor” refers to a hardware component or a combination of hardware and software components that executes computer-readable instructions to perform the operations described in the claims, including acquiring, analyzing, converting, generating, and transmitting data.

The term “inquiry content” refers to information, including questions, requests, complaints, or other communications, that a user provides to the system in natural language.

The term “natural language processing technique” refers to a computational technique or set of techniques for processing and analyzing text expressed in human language, including, for example, tokenization, morphological analysis, grammatical analysis, and semantic analysis.

The term “text data” refers to data representing characters, words, sentences, or other linguistic units encoded in a machine-readable format, which are derived from the user's inquiry content.

The term “morphological analysis” refers to processing that identifies and classifies morphemes or word units in text data, including, for example, detecting word boundaries, parts of speech, and inflectional forms.

The term “grammatical analysis” refers to processing that analyzes the syntactic structure of text data, including, for example, identifying dependencies, phrase structures, and grammatical relations among words or morphemes.

The term “structured data” refers to data that is organized according to a predefined schema or data model, representing elements such as tokens, parts of speech, syntactic relationships, entities, or intents, such that the data can be programmatically referenced and processed.

The term “prompt sentence” refers to a text sequence provided as input to a generative artificial intelligence model, which describes instructions, conditions, or contextual information for causing the model to generate a specific response.

The term “generative artificial intelligence model” refers to a machine learning model, such as a large language model or other generative model, that generates natural language text or other output data in response to input data including a prompt sentence.

The term “specific response” refers to a natural language output or other content that the generative artificial intelligence model generates in accordance with the instructions or conditions specified by the prompt sentence, and that is intended to address the user's inquiry content.

The term “related keywords” refers to words or phrases extracted from the inquiry content or derived from the analysis of the inquiry content, which represent important concepts, entities, or topics relevant to the user's intent.

The term “context” refers to information about the circumstances, relationships, or background associated with the inquiry content, including, for example, preceding or surrounding text, user status, or historical interaction data.

The term “natural language response” refers to a response generated by the generative artificial intelligence model that is expressed in a human language and is intended to be understandable by the user.

The term “terminal” refers to an electronic device used by the user to send inquiry content to the system and receive responses from the system, including, for example, a smartphone, tablet, personal computer, or other communication device.

The term “in real time” refers to processing and transmission performed with a delay that is short enough that the user can perceive the response as being provided immediately or almost immediately after the user's inquiry.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

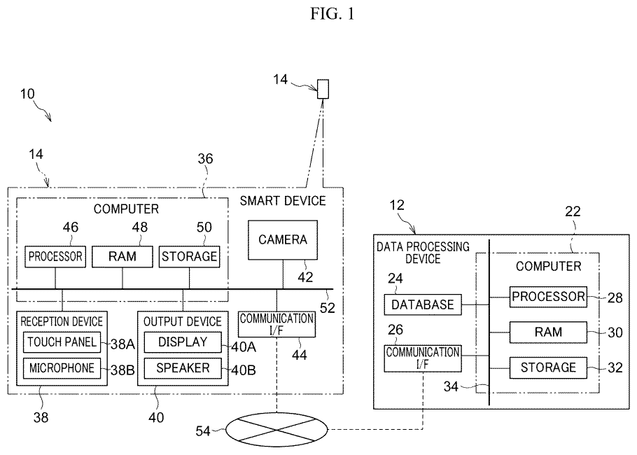

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

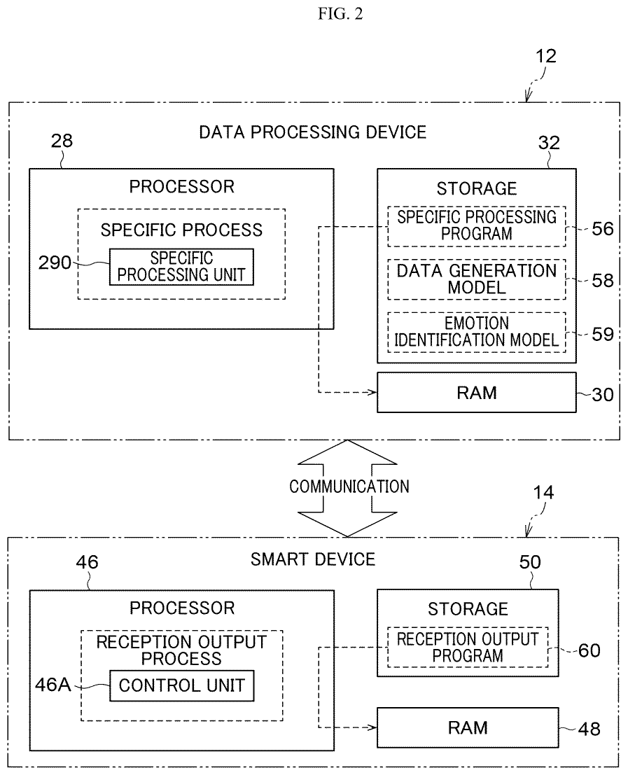

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented inquiry response systems suffer from multiple technical limitations in how text data from users is processed, stored, and used to generate responses. In many existing systems, a server simply forwards raw text inquiries to a response engine or rules engine without performing rich linguistic analysis or structured feature extraction. As a result, the server cannot accurately capture semantic features such as user intent, contextual relationships between terms, or meaningful keyword groupings, and therefore cannot effectively control or guide a generative AI model. This leads to unstable response quality, inconsistent behavior across similar inputs, and inefficient use of computational resources when performing natural language processing and response generation.

Furthermore, conventional systems typically do not maintain analysis results in a form suitable for systematic reuse as learning data. Raw logs of user inquiries and responses may be stored, but they are not organized as structured training data associating inquiry intent classes, semantic feature values, and response outcomes. Consequently, the generative AI model cannot be efficiently retrained or fine-tuned based on accumulated interaction history, which limits continuous performance improvement and makes it difficult to adapt to domain-specific usage patterns. This lack of structured feedback also prevents the server from improving the accuracy and reliability of generated responses over time.

In addition, existing systems often provide a generative AI model with only a simple prompt consisting of the user's original text, without explicitly encoding intent classes, keyword groups, or response constraints. Because the model is not guided by a structured prompt sentence that reflects detailed analysis results and system-side policies, the model may generate responses that are overly long, off-topic, or inconsistent with service rules. Such behavior degrades user experience and can increase network and processor load due to repeated or unnecessary queries.

From a computer technology standpoint, there is a need for a server-side mechanism that (i) systematically converts user inquiry text into structured data through multi-stage linguistic and machine learning analysis, (ii) stores analysis results in a reusable training-data format, and (iii) generates structured prompt sentences that precisely guide a generative AI model. Such a mechanism should improve the technical performance of the inquiry response pipeline, including response accuracy, consistency, and processing efficiency, by leveraging structured analysis and feedback loops rather than ad-hoc text forwarding.

The specific processing by the specific processing unit 290 of the data processing device 12 in Example 1 is realized by the following means.

The present invention provides a server comprising a processor and a storage device, the processor being configured to acquire inquiry content transmitted from a user via a communication terminal as text data and store the text data in the storage device, to perform natural language processing on the text data by executing linguistic preprocessing including morphological analysis, syntactic analysis, segmentation, part-of-speech assignment, removal of unnecessary terms, and normalization of word forms to convert the text data into structured data, to apply a statistical learning algorithm or a machine learning algorithm to the structured data to calculate semantic feature values and identify, based on the semantic feature values, an intent class corresponding to the inquiry content and a group of highly relevant terms, to store, as analysis results, the intent class, the group of highly relevant terms, and an original text of the inquiry content as training data in the storage device in a format usable for learning or performance improvement of a generative AI model, to periodically extract the training data and update parameters of the generative AI model based on the training data, to generate, based on the analysis results, a structured prompt sentence that integrates the intent class, the group of highly relevant terms, the original text, and response generation constraints, and to input the structured prompt sentence and the inquiry content into the generative AI model to cause the generative AI model to generate a natural language response, and to perform post-processing including content checking and format adjustment on the natural language response and transmit the post-processed natural language response as a text message to the communication terminal. This enables improved technical performance of the inquiry response system by allowing the server to derive and store rich semantic representations of user inquiries, to use those representations as structured training data for iterative refinement of the generative AI model, and to guide the generative AI model with structured prompt sentences so that the generated responses are more accurate, consistent, and computationally efficient compared to systems that rely only on unstructured raw text input.

The term “inquiry content” refers to information expressed in natural language that a user submits to a system via a communication terminal, the information typically including a question, request, or instruction for which the user seeks a response.

The term “communication terminal” refers to an electronic device operated by a user and configured to transmit inquiry content to a server and receive responses from the server via a communication network, the electronic device including, for example, a portable terminal, a stationary terminal, or a general-purpose computing device.

The term “text data” refers to digital data representing characters or symbols in a machine-readable format, the digital data being suitable for processing by a processor using natural language processing algorithms.

The term “storage device” refers to a hardware component or combination of hardware components configured to store digital data, including volatile or non-volatile memory, magnetic storage, optical storage, or solid-state storage.

The term “natural language processing” refers to a series of computational techniques and algorithms that analyze and transform text data expressed in human language, in order to derive linguistic structure, semantics, or other features usable for subsequent processing.

The term “morphological analysis” refers to a processing operation that divides text data into morphemes or word units and identifies attributes such as base forms, inflectional forms, or lexical categories for the respective units.

The term “syntactic analysis” refers to a processing operation that determines grammatical relationships between tokens or word units in text data, including at least one of parsing, dependency analysis, or phrase structure analysis.

The term “segmentation” refers to a processing operation that divides a sequence of characters or tokens into discrete units such as words, phrases, or sentences, for use in subsequent linguistic or statistical analysis.

The term “part-of-speech assignment” refers to a processing operation that assigns grammatical categories such as noun, verb, adjective, or adverb to respective tokens or word units in text data.

The term “removal of unnecessary terms” refers to a processing operation that eliminates tokens or word units that are judged to have low semantic contribution for a given task, including at least one of function words, stop words, or punctuation marks.

The term “normalization of word forms” refers to a processing operation that converts word forms into standardized representations, including at least one of converting inflected forms to base forms, harmonizing character case, or converting synonymous notations to a canonical form.

The term “structured data” refers to data in which information elements derived from text data are organized into predefined formats or fields, such as records including intent labels, keywords, or feature vectors, thereby enabling efficient computational processing and storage.

The term “statistical learning algorithm” refers to a computational method that infers patterns or models from data based on statistical principles, without being explicitly programmed with rules for each case, the method including at least one of regression, classification, or clustering techniques.

The term “machine learning algorithm” refers to a computational method that automatically adjusts internal parameters of a model based on training data so as to perform tasks such as classification, prediction, or feature extraction, the computational method including supervised, unsupervised, or reinforcement learning.

The term “semantic feature values” refers to numerical or categorical representations that encode meaning-related attributes of text data, including at least one of embedding vectors, topic probabilities, or intent scores.

The term “intent class” refers to a category label indicating a type of user objective or purpose inferred from inquiry content, such as a product return request, a status inquiry, or a usage guidance request.

The term “group of highly relevant terms” refers to a set of tokens, keywords, or expressions that are determined, based on semantic feature values or statistical measures, to have a strong relationship with a specific inquiry content or intent class.

The term “analysis results” refers to information derived from processing text data, including at least one of structured data, semantic feature values, intent classes, and groups of highly relevant terms, which is used for subsequent operations such as training data generation or prompt construction.

The term “training data” refers to data used to train, fine-tune, or improve a model, the data including pairs or sets of inputs and corresponding outputs or labels, such as inquiry content, analysis results, and associated responses.

The term “generative AI model” refers to an artificial intelligence model that generates output data, such as natural language text, in response to input data, the model typically including a neural network configured for sequence generation or transformation.

The term “prompt sentence” refers to a textual instruction or input sequence supplied to a generative AI model, the instruction or input sequence controlling behavior of the model and including at least one of system directives, user messages, analysis results, and response constraints.

The term “structured prompt sentence” refers to a prompt sentence in which multiple information elements, such as an intent class, a group of highly relevant terms, an original text of inquiry content, and constraint conditions, are combined according to a predefined format or structure to systematically guide a generative AI model.

The term “response policy” refers to one or more rules, guidelines, or parameters that specify how a generative AI model should generate a natural language response, including at least one of tone, length, coverage of topics, or compliance with service constraints.

The term “response generation constraints” refers to conditions or limitations applied to the content or form of a generated response, including at least one of mandatory inclusion or exclusion of specific information, maximum length, or adherence to predetermined styles or policies.

The term “natural language response” refers to text data generated by a generative AI model in a human language and intended to answer, explain, or otherwise respond to a user's inquiry content.

The term “post-processing” refers to one or more operations performed on a generated natural language response after generation by a model, including at least one of content checking, safety filtering, formatting, and conversion into a message suitable for transmission.

The term “historical response data” refers to stored records of past interactions between users and a system, including at least inquiry content, analysis results, and corresponding natural language responses, used for evaluation, training, or improvement of models.

The term “parameter update” refers to a modification of numerical values or settings inside a generative AI model performed based on training data, the modification being executed to improve performance metrics such as accuracy, relevance, or stability of generated responses.

In one embodiment, a server provides a computer-implemented inquiry response system that uses structured natural language processing and a generative AI model to generate responses to user inquiries. The server includes at least one processor, a main memory, a non-volatile storage device, and a network interface. The server is connected via a communication network to at least one terminal operated by a user. The terminal may be implemented as a portable device or a general-purpose computing device executing a web browser or a dedicated application.

The user operates the terminal to input inquiry content as natural language text through a graphical user interface. The terminal converts the inquiry content into text data and transmits the text data to the server through a network protocol such as HTTP or HTTPS. The terminal receives a natural language response from the server and presents the response on a display screen. The terminal, by performing these input and output operations, cooperates with the server but does not perform the core linguistic and machine learning computations.

The server executes a program that is stored in the non-volatile storage device and loaded into main memory. The server uses an operating system, for example a general-purpose server operating system, and a runtime environment capable of executing software components written in a general-purpose programming language such as a scripting language or a compiled language. In one embodiment, the server executes a web application framework to receive and respond to network requests from the terminal.

The server acquires inquiry content as text data and stores the text data in a storage device configured as a database system. The server may use a relational database management system to store records in tables such as an inquiry table, an analysis result table, and a response table. Each record of the inquiry table may include fields such as an inquiry identifier, a user identifier, a timestamp, and a message string containing the original inquiry text. By structuring inquiry content in this manner, the server can index and retrieve inquiry records efficiently, which contributes to improved access performance and reduced processor overhead when processing large volumes of inquiries.

The server performs natural language processing on the stored text data using a combination of software libraries and algorithms. In one embodiment, the server uses a natural language processing toolkit and a syntactic analysis library running on the server's central processing unit and, optionally, on an attached graphics processing unit. The server executes morphological analysis to split the text into tokens, assign base forms to inflected words, and generate token-level attributes. The server executes syntactic analysis to identify syntactic dependencies between tokens and to construct a parse tree or dependency graph for each sentence.

The server further performs preprocessing operations including segmentation into sentences and phrases, part-of-speech assignment, removal of unnecessary terms such as stop words and punctuation tokens, and normalization of word forms such as converting words to lower case, unifying spelling variants, and mapping synonyms to canonical terms. The server represents the results of these operations as structured data, for example as records containing token sequences, part-of-speech tags, dependency relations, and normalized tokens. By performing this structured preprocessing, the server reduces input variation, which improves the stability and accuracy of downstream feature extraction and model inference. This improves computer performance by reducing the dimensionality of token representations and by enabling efficient vectorization.

The server computes semantic feature values for each inquiry by using a machine learning model that maps text to a numerical vector representation. In one embodiment, the server uses a neural network-based embedding model implemented using a machine learning framework such as a tensor-based computation library. The embedding model may be a transformer architecture having multiple encoder layers, self-attention mechanisms, and feed-forward networks. The server inputs the tokenized and normalized text sequences into the embedding model, which outputs a fixed-dimensional embedding vector for each inquiry. This embedding vector constitutes a semantic feature value that encodes contextual relationships among tokens in a way that is not obtainable by simple keyword matching.

The server identifies an intent class for each inquiry by applying a classifier model to the semantic feature values. In one embodiment, the server uses a neural network classifier, for example a feed-forward network or a transformer-based classifier, that has been trained to output probabilities over a set of intent classes such as product return inquiries, product exchange inquiries, and shipping status inquiries. The server calculates a probability distribution over the intent classes and selects the intent class with the highest probability as the primary intent, while retaining the probability values as confidence scores. The server also identifies a group of highly relevant terms by combining the syntactic and morphological analysis results with feature importance measures derived from the classifier (for example, attention weights or gradient-based importance scores). This non-conventional combination of syntactic structure and learned feature importance allows the server to select terms that have strong semantic contribution to the detected intent, which goes beyond simple frequency-based keyword extraction.

The server stores the analysis results in the storage device as training data for the generative AI model. The server records the intent class, the group of highly relevant terms, the original inquiry text, and the semantic feature values in an analysis result table. The server may store the embedding vectors as binary large objects or compressed numeric arrays. By maintaining this structured association among original text, intent, keywords, and semantic features, the server constructs a training dataset that can be reused for model refinement. This storage structure improves data management by making it easy to filter training data by intent class, by time period, or by quality criteria, which contributes to efficient training and reduces computation required to construct training batches.

The server periodically performs learning or fine-tuning of the generative AI model using the accumulated training data. The generative AI model may be implemented as a transformer-based sequence-to-sequence neural network comprising an encoder-decoder architecture or a decoder-only architecture, with multiple attention layers, residual connections, and layer normalization. The server defines a loss function such as a cross-entropy loss between generated tokens and target tokens in stored historical responses. The server performs backpropagation to compute gradients of the loss function with respect to network weights and uses a gradient-based optimizer such as stochastic gradient descent or an adaptive learning rate method to update the weights. The server may perform data augmentation by, for example, shuffling paraphrases or masking certain tokens to improve robustness. This internal training loop is executed on specialized hardware such as a graphics processing unit, which improves training speed and permits handling of large model sizes and datasets.

The server constructs a prompt sentence for the generative AI model in a structured manner. The server reads the inquiry record and associated analysis result record from the storage device and integrates multiple information elements into a single text sequence. For example, the server may generate a prompt sentence such as:
“System: You are a customer support assistant for an online service. Use the intent and keywords below to generate a clear and polite answer.
Intent: product_return_inquiry
Keywords: [product, return, method]
User message: ‘Please tell me how to return a product.’
Task: Provide step-by-step instructions for returning a purchased product, including any deadlines and conditions.”

Alternatively, the server may generate a prompt sentence such as:
“User inquiry: ‘I purchased a product but it arrived damaged. Please tell me the return or exchange procedure.’
Detected intent: product_return_inquiry
Extracted terms: [damaged, product, return, exchange, procedure]
Instruction: Generate a concise and polite response that explains the procedure for returning or exchanging a damaged product, including necessary steps and any applicable deadlines.”

The server, by including explicit tags such as “Intent,” “Keywords,” and “Instruction,” imposes a structured format on the prompt sentence. This structured prompt sentence informs the generative AI model of the intended task, context, and constraints and thereby reduces ambiguity. As a result, the generative AI model can converge on appropriate response patterns with fewer tokens and less computation than would be required if it received only the raw user text. This leads to improved generation speed and reduced communication load when using an external model endpoint.

The server inputs the structured prompt sentence, along with the original inquiry content if desired, to the generative AI model. The generative AI model executes on the same server or on a different computation node accessible via the network. During inference, the generative AI model processes the input token sequence through its multi-layer transformer network. At each layer, the model performs matrix multiplications and attention operations over the token embeddings and positional encodings. The model then computes output token probabilities at each generation step. The server controls generation parameters such as maximum number of tokens, temperature, and sampling strategy (e.g., top-k or nucleus sampling) to balance determinism and variability. By controlling these parameters programmatically, the server adapts response generation to device constraints and service requirements, such as limiting response length to reduce bandwidth usage for mobile terminals.

The server receives the generated natural language response from the generative AI model and performs post-processing. The server may apply safety and compliance checks using rule-based filters or auxiliary classifier models that scan the output for prohibited terms, private information, or inconsistencies with service rules. The server may reformat the response text into bullet points, numbered steps, or short paragraphs, depending on the device type of the terminal and the screen size. The server may also insert hyperlinks or identifiers corresponding to help articles in a knowledge base. This adaptive formatting improves the usability of the response and reduces the need for the user to request clarifications, thereby decreasing the overall number of interactions, network round trips, and processor cycles.

The server transmits the post-processed response to the terminal as structured response data. The terminal receives the response, decodes the text, and displays it to the user using a user interface element such as a text area or a dialog. The user reads the response and may decide to input a follow-up inquiry. Because the intents and analysis results are stored, the server can reuse previous semantic features and structured elements to construct subsequent prompt sentences, which reduces re-computation and contributes to lower latency in multi-turn conversations.

From a technical perspective, the described system improves computer technology in several ways. First, by converting raw natural language input into structured data that includes semantic feature values and intent classes, the server enables more efficient memory usage and faster retrieval operations compared to storing only unstructured text. Second, by generating structured prompt sentences that explicitly encode intent, key terms, and constraints, the server reduces the search space of the generative AI model and achieves faster and more accurate convergence during inference, which improves computation throughput. Third, by continuously collecting structured analysis results as training data and periodically updating model parameters, the server adaptively optimizes the generative AI model for the specific domain and usage patterns of the system, which yields improved response accuracy and lower error rates over time. Fourth, by using multi-stage analysis (linguistic preprocessing, semantic embedding, intent classification, and keyword selection) combined with non-traditional, model-based importance measures, the system performs processing that differs from simple human reading or manual rule creation and achieves an automated feature extraction pipeline that is not a mere automation of human mental steps.

In additional embodiments, the server may employ alternative neural network architectures for the generative AI model, such as recurrent neural networks with attention mechanisms or hybrid models combining convolutional and transformer layers. The server may change the loss function to include regularization terms that penalize overly long or off-topic responses, thereby further shaping model behavior. The server may apply different optimization algorithms, learning rate schedules, or batch sampling strategies to adapt training to hardware constraints. The server may implement caching of intermediate representations, such as semantic feature vectors or partial model outputs, in order to accelerate responses to repeated or similar inquiries. By explicitly defining and controlling these technical parameters of computation, memory, and network usage, the system provides concrete improvements in processing efficiency and response quality beyond abstract data manipulation.

In further embodiments, the server may operate in a distributed environment in which different functional modules, such as the natural language processing module, the semantic feature computation module, the intent classification module, and the generative AI inference module, are deployed on separate nodes. The server may orchestrate data flow between these nodes using message queues and load balancers. Such distributed arrangements enable the system to scale to high query volumes while maintaining low latency. The structured data and prompt construction methods described above allow each module to process compact and semantically rich representations, thereby reducing inter-node communication load and improving overall system throughput.

The user, the terminal, and the server cooperate in these embodiments to realize an inquiry response system in which the computer performs advanced, structured linguistic and machine learning operations that improve the underlying processing technology. The system does not merely replace human reading and writing, but instead reorganizes text data into machine-optimized structures, uses these structures to train and guide a generative AI model with specific architectures and learning rules, and thereby achieves technical effects such as reduced computation time, improved model accuracy, and decreased network traffic.

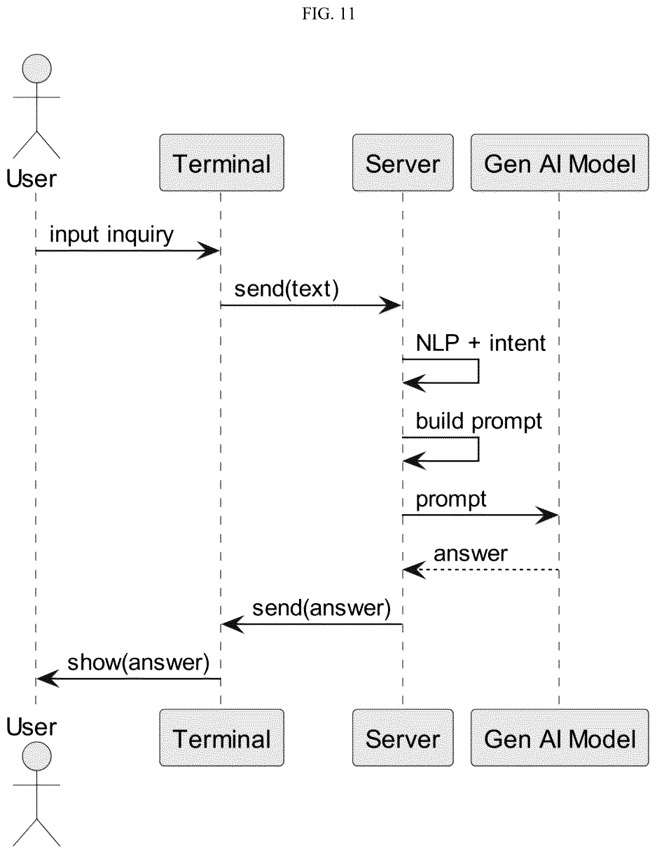

The following describes the processing flow using FIG. 11.

### Step 1:

The user operates the terminal to input inquiry content as natural language text, such as “Please tell me how to return a product,” into an input field of a user interface. The terminal receives, as input, the raw character sequence entered by the user together with metadata such as a user identifier and a timestamp. The terminal converts this input into structured text data, for example an internal object containing fields for user ID, time, and message, and encodes the text using a character encoding such as UTF-8. The terminal outputs the structured text data and transmits it to the server over a communication network using a network protocol such as HTTP or HTTPS.

### Step 2:

The server receives, as input, a network request containing the structured text data from the terminal via a network interface. The server parses the request, validates that required fields such as user ID and message are present, and converts the request body into an internal data structure suitable for processing by the application. The server then performs data insertion operations into a storage device, such as executing an insert command on a database, and stores the inquiry content together with metadata in an inquiry table. The server outputs a stored record identifier and an in-memory representation of the inquiry text for subsequent processing.

### Step 3:

The server obtains, as input, the stored inquiry record and the associated message string from the database. The server loads the message text into a natural language processing module and executes preprocessing operations including segmentation into sentences, tokenization into word units, and character normalization. The server then performs morphological analysis and part-of-speech assignment using a linguistic analysis library, thereby transforming the raw text into a sequence of tokens with associated base forms and grammatical categories. The server outputs structured linguistic data, for example a token list with attributes, which serves as a basis for syntactic and semantic processing.

### Step 4:

The server takes, as input, the tokenized and morphologically analyzed data from Step 3. The server executes syntactic analysis using a parsing algorithm to determine grammatical relations between tokens and to build a syntactic representation such as a dependency tree or phrase structure. During this computation, the server calculates relationships such as subject-verb and object-verb pairs by applying parsing rules and probabilistic models. The server outputs syntactic structures and dependency relations that describe the grammatical organization of the inquiry content.

### Step 5:

The server receives, as input, the tokens, part-of-speech tags, and syntactic structures generated in the previous steps. The server performs additional preprocessing by removing unnecessary terms such as stop words, punctuation, and tokens with low semantic contribution, and by normalizing word forms to canonical representations. The server then constructs normalized token sequences and phrase units suitable for vectorization. The server outputs cleaned and normalized text representations that reduce variation and dimensionality for subsequent machine learning computations.

### Step 6:

The server uses, as input, the normalized text representations from Step 5. The server computes semantic feature values by passing these text sequences through an embedding model implemented as a neural network, such as a transformer-based encoder. The server converts tokens into embedding vectors, applies multiple layers of self-attention and feed-forward transformations, and aggregates the outputs to obtain a fixed-dimensional semantic embedding representing the entire inquiry. The server outputs a numerical feature vector, such as a floating-point array, that encodes the semantic meaning of the inquiry content.

### Step 7:

The server accepts, as input, the semantic feature vector from Step 6. The server applies a classification model, such as a neural network classifier, which computes a probability distribution over predefined intent classes by performing matrix multiplications, non-linear activations, and softmax normalization. The server selects an intent class with the highest probability and calculates confidence scores for each class. The server then identifies a group of highly relevant terms by combining feature importance values derived from the classifier with the token-level information and syntactic structures. The server outputs an intent label, associated confidence values, and a list of highly relevant terms related to the inquiry.

### Step 8:

The server receives, as input, the intent label, the list of highly relevant terms, the semantic feature vector, and the original inquiry text. The server aggregates these elements into an analysis result object and stores this object in an analysis result table in the database. The server formats the semantic feature vector into a storable representation such as a binary large object or serialized numeric array and associates it with the corresponding inquiry identifier. The server outputs a persistent analysis record that can be reused as training data for a generative AI model and as context for prompt generation.

### Step 9:

The server takes, as input, multiple historical analysis records and their associated responses from the storage device during a training phase. The server constructs training batches by pairing inquiries, intent labels, and responses, and feeds these batches into a generative AI model implemented as a transformer-based neural network. The server computes a loss value, for example cross-entropy between generated token distributions and target tokens, and performs backpropagation to obtain gradients. The server updates model parameters using an optimization algorithm such as stochastic gradient descent with adaptive learning rates. The server outputs an updated generative AI model whose internal weights are adjusted to better fit the accumulated interaction data, thereby improving future response accuracy.

### Step 10:

The server uses, as input, the inquiry-specific analysis record from Step 8 for a current interaction. The server constructs a structured prompt sentence by integrating the intent class, the group of highly relevant terms, the original user message, and explicit instructions or constraints into a single text sequence. Concretely, the server may generate a prompt sentence such as:
“System: You are a customer support assistant for an online service. Use the intent and keywords below to generate a clear and polite answer.
Intent: product_return_inquiry
Keywords: [product, return, method]
User message: ‘Please tell me how to return a product.’
Task: Provide step-by-step instructions for returning a purchased product, including any deadlines and conditions.”

The server outputs the structured prompt sentence as a text string suitable for input to the generative AI model.

### Step 11:

The server receives, as input, the structured prompt sentence from Step 10 and, optionally, the semantic feature vector or other context data. The server tokenizes the prompt sentence, encodes tokens into numerical embeddings, and supplies the token sequence to the generative AI model for inference. The generative AI model processes the input through multiple transformer layers, computing attention scores and layer outputs at each step, and generates output tokens one by one according to configured parameters such as maximum output length and sampling strategy. The server collects the generated tokens and decodes them into a natural language response string. The server outputs the raw generated response text that addresses the user's inquiry.

### Step 12:

The server takes, as input, the raw generated response text from Step 11. The server performs post-processing operations including content checking, format adjustment, and optional insertion of references or links. For content checking, the server may apply rule-based filters or auxiliary classifiers to detect prohibited expressions, personal data, or inconsistencies with service policies, and may modify or truncate the response if necessary. For format adjustment, the server may add headings, bullet points, or numbered steps to make instructions clear on the terminal display. The server outputs a sanitized and formatted response message suitable for transmission.

### Step 13:

The server receives, as input, the sanitized and formatted response message produced in Step 12. The server encapsulates this message in a network response, such as an HTTP or HTTPS response, and sets appropriate headers and status codes. The server then transmits the response over the communication network to the terminal. The terminal receives the response, extracts the response text, and renders it on the display for the user using user interface components. The terminal outputs the displayed natural language response, and the user visually perceives the content and may decide whether to submit a follow-up inquiry, which initiates a new execution of the preceding steps.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional dialog systems that use language models to generate customer support responses typically relay user inquiries as plain text to a generative AI model and directly forward the returned text to a user terminal. Such systems often lack structured analysis of the inquiry, do not explicitly determine missing information, and do not integrate user feedback into the control logic of prompt construction. As a result, the systems exhibit unstable answer quality, redundant or irrelevant responses, repeated follow-up questions, and inefficient use of computational resources. From a computer technology perspective, these shortcomings manifest as suboptimal orchestration of natural language processing components, insufficient control over the input to the generative AI model, and an inability to adapt internal processing parameters based on runtime feedback signals.

In many implementations, the processor merely performs simple text preprocessing and invokes a generative AI model with a static, hand-written prompt, without using structured data such as intent information, key term information, or target information. The processor does not classify the inquiry type, does not reason about what additional information is missing, and does not adjust the prompt content or model usage conditions based on past performance. This leads to unnecessary load on external models, increased network traffic, and longer end-to-end latency, because the model is repeatedly asked to infer context that could have been computed locally in a more deterministic and efficient manner.

Furthermore, existing systems generally treat user feedback as an external business metric rather than as structured learning data directly linked to the internal processing pipeline. Feedback, if stored at all, is not consistently associated with the original inquiry, the specific prompt sentence that was transmitted, and the exact response text generated by the model. Therefore, the processor cannot systematically aggregate and analyze feedback to refine classification rules, update parameters of an intent identification model, or optimize template information for prompt sentences. This lack of closed-loop adaptation results in limited improvement of the system over time and hinders technical advancements in response selection, prompt construction, and resource management.

Accordingly, there is a need for a computer-implemented system that technically improves the operation of a server by: (i) converting user inquiries into structured data through natural language processing; (ii) determining inquiry classification and missing information; (iii) automatically constructing context-aware prompt sentences tailored to a generative AI model; (iv) performing post-processing of model outputs to generate user-oriented response messages; and (v) collecting, associating, and analyzing feedback information as learning data to update prompt templates, generation conditions, classification rules, and intent estimation models. Such a system should improve accuracy, consistency, and efficiency of generated responses, reduce computational overhead at the model and network level, and provide a technical mechanism for continuous optimization of the server's dialog control logic.

The specific processing by the specific processing unit 290 of the data processing device 12 in Application Example 1 is realized by the following means.

The present invention provides a server comprising a processor configured to receive text information including a user inquiry from a user terminal via a communication network, acquire the text information as electronic data together with additional information including at least one of a request item and identification information, execute natural language processing on the text information to perform at least word segmentation, removal of unnecessary words, normalization of word forms, assignment of parts of speech, semantic analysis, and normalization of expressions, convert the inquiry into structured data including at least intent information, important word information, and target information, determine, based on the structured data, a classification result of the inquiry and presence or absence of missing information, determine a type of additional information required for resolution of the inquiry, generate, based on the structured data and the type of additional information, a prompt sentence for instructing a generative AI model to generate a natural language response by combining the inquiry and metadata with template information stored in a storage device, transmit the prompt sentence to the generative AI model via a communication interface, acquire a response text in natural language from the generative AI model, execute post-processing on the response text including at least content inspection, length adjustment, conversion of expression format, and insertion of additional information to generate a user-oriented response message, transmit the user-oriented response message in real time to the user terminal, receive, from the user terminal, feedback information including at least one of evaluation information and comment information regarding the response message, store the feedback information in association with the inquiry, the prompt sentence, and the response text, aggregate and analyze the stored feedback information, and update at least one of the template information, a generation condition for the prompt sentence, a classification rule for the inquiry, and a parameter of an identification model for intent estimation based on a result of the analysis. This enables an improvement in computer functionality by allowing the server to control input to the generative AI model using structured representations of inquiries, to automatically adapt prompt construction and model usage conditions based on runtime feedback, to reduce unnecessary computation and network traffic, and to increase accuracy, consistency, and efficiency of generated responses in a continuous, data-driven manner.

The term “processor” refers to a hardware or virtual computation unit, including at least one central processing unit core or an equivalent processing resource, that executes instructions of a program to perform data processing operations described in this specification.

The term “system” refers to an arrangement including at least one processor, at least one memory, and at least one communication interface, configured to execute the processing operations described in the claims.

The term “user” refers to a human operator who issues an inquiry and receives a response message through a terminal.

The term “terminal” refers to an information processing device, such as a client device, including at least one input unit, at least one output unit, and a communication function, used by a user to transmit inquiries and receive response messages.

The term “communication network” refers to a wired or wireless data communication infrastructure, including at least one of a local network and a wide-area network, that enables data transfer between the terminal and the server.

The term “text information” refers to data representing a sequence of characters, symbols, or lexical units encoded in a machine-readable format, which includes at least an inquiry expressed in natural language.

The term “inquiry” refers to a request or question expressed by a user in natural language, concerning at least one service, product, or operation, and intended to obtain an answer or guidance.

The term “electronic data” refers to information represented in a digital format suitable for storage, transmission, and processing by the processor.

The term “additional information” refers to auxiliary data transmitted together with or separately from an inquiry, including at least one of a request item, identification information, timestamp, or context information.

The term “request item” refers to a data element that specifies a category, topic, or functional operation requested by the user in association with an inquiry.

The term “identification information” refers to data that uniquely or semi-uniquely identifies at least one of a user, a session, an inquiry, or a transaction, including at least one of an identifier, account information, or tracking information.

The term “natural language processing” refers to a series of computational techniques for analyzing, interpreting, and transforming human language text using algorithms executed by the processor.

The term “language processing program” refers to software instructions, including at least one library or module, that configure the processor to perform natural language processing operations.

The term “word segmentation” refers to a process in which a continuous character string is divided into lexical units, such as words or tokens, according to language rules or statistical models.

The term “removal of unnecessary words” refers to a process of excluding tokens that have low semantic contribution, such as function words or stop words, from further analysis.

The term “normalization of word forms” refers to a process of converting inflected or variant forms of words into canonical forms, such as lemmas or stems.

The term “assignment of parts of speech” refers to a process of assigning grammatical category labels, such as noun, verb, or adjective, to each token.

The term “semantic analysis” refers to a process of extracting meaning-related information from text, including at least one of word sense, relations between terms, or roles of entities.

The term “normalization of expressions” refers to a process of converting different surface expressions that have similar meanings into a standardized representation.

The term “structured data” refers to information organized into a predefined data structure, such as a record, list, or key-value set, in which elements such as intent information, important word information, and target information are explicitly represented.

The term “intent information” refers to data representing a computationally inferred purpose or goal of an inquiry, such as a type of problem or requested action.

The term “important word information” refers to data representing tokens or phrases that have high relevance for understanding or processing an inquiry, extracted from text by natural language processing.

The term “target information” refers to data indicating an object, subject, or resource that is referenced or affected by an inquiry, such as a product, service, or transaction.

The term “classification result of the inquiry” refers to data representing a category or label assigned to an inquiry according to a classification rule or model, such as a type of issue, domain, or topic.

The term “missing information” refers to data items that are required for resolution of an inquiry but are not explicitly contained in the received information.

The term “type of additional information” refers to a specification of which data elements, such as an identifier or attribute, are required as missing information to resolve an inquiry.

The term “prompt sentence” refers to a text string constructed for input to a generative AI model, which includes at least one instruction, context, and user inquiry information, and which guides generation of a response in natural language.

The term “metadata” refers to auxiliary data describing properties of an inquiry, structured data, or processing context, including at least one of intent labels, language indicators, or importance scores.

The term “template information” refers to stored data structures that define a format or pattern for constructing a prompt sentence or response message, including fixed and variable portions to be combined.

The term “storage device” refers to a hardware component, such as a memory or persistent storage, configured to store template information, structured data, feedback information, and other processing-related data.

The term “communication interface” refers to a hardware and software component set that enables the processor to send and receive data over a communication network using at least one communication protocol.

The term “generative AI model” refers to a machine learning model configured to generate text in natural language based on an input prompt or context, by performing numerical operations on parameterized representations.

The term “response text” refers to natural language text generated by the generative AI model in response to a prompt sentence.

The term “content inspection” refers to a process of checking a response text against predetermined rules or criteria, including at least one of blocking prohibited expressions, removing sensitive information, or verifying relevance.

The term “length adjustment” refers to a process of modifying the length of a response text, including at least one of truncation, summarization, or expansion, to meet constraints or policies.

The term “conversion of expression format” refers to a process of changing a style or representation of text, such as formatting, tone, or language register, without altering the essential meaning.

The term “insertion of additional information” refers to a process of adding extra content, such as links, identifiers, or instructions, to a response text to generate a final response message.

The term “user-oriented response message” refers to a response text that has been post-processed and formatted for presentation to a user through a terminal interface.

The term “real time” refers to a response behavior in which the system transmits a response message with a latency that is short enough to support interactive communication from a user's perspective.

The term “feedback information” refers to data provided by a user or terminal that evaluates or comments on a response message, including at least evaluation information and comment information.

The term “evaluation information” refers to structured data representing a quantitative or qualitative rating of response quality, such as a score, ranking, or binary indicator.

The term “comment information” refers to additional text or signals provided by a user that describe reasons for evaluation or detailed impressions regarding a response message.

The term “association” refers to a logical linkage or referencing relationship established in storage between multiple data elements, such as an inquiry, a prompt sentence, a response text, and feedback information.

The term “aggregate” refers to a process of collecting multiple items of feedback information and computing statistical or summary values over them.

The term “analyze” refers to a process of applying computational techniques, including at least one of statistical analysis, pattern recognition, and machine learning, to interpret feedback information and derive insights.

The term “generation condition for the prompt sentence” refers to parameters or rules that control how a prompt sentence is constructed, including at least one of template selection, phrasing options, and inclusion of metadata.

The term “classification rule for the inquiry” refers to a set of conditions, mappings, or learned parameters used by the processor to determine a category or label for an inquiry.

The term “identification model for intent estimation” refers to a computational model that receives at least text information or structured data as input and outputs an estimated intent label or score.

The term “group of learning data” refers to a collection of feedback information items, and optionally associated inquiries, prompt sentences, and response texts, used as training or evaluation data for updating models or rules.

The term “expression pattern of the template information” refers to a particular arrangement or phrasing style defined within template information, which affects how instructions and context are expressed in a prompt sentence or response message.

The term “input format to the generative AI model” refers to a structural and syntactic specification of how a prompt sentence, context, and parameters are provided to the generative AI model.

The term “presentation format of the response message” refers to a layout, structure, or style in which a response message is displayed or presented on a user terminal.

In one embodiment, a server implements the claimed system using a general-purpose information processing apparatus such as a rack-mounted computer including at least one central processing unit, a main memory, a non-volatile storage device, and a communication interface. The server executes an operating system such as a general-purpose server operating system, and application software implemented, for example, using a server-side framework such as a web application framework. The server further uses a natural language processing library such as spaCy or NLTK, and accesses a generative AI model provided via an external application programming interface. The server communicates with at least one terminal operated by a user via a communication network such as the Internet, a wireless wide-area network, or a local area network.

The terminal is, for example, a smartphone, a tablet, or a personal computer, including a processor, a memory, a display, an input device, and a communication module. The terminal executes a web browser application or a native client application and provides a graphical user interface through which the user can input an inquiry and view a response message. The user operates a text input widget on the terminal to enter an inquiry such as “My package has not arrived yet. What should I do?” and initiates transmission of the inquiry by an explicit operation such as pressing a send button.

The server receives the inquiry text as electronic data via the communication interface, typically encapsulated in a request message following a standard communication protocol such as Hypertext Transfer Protocol over Transport Layer Security. The server stores the received data temporarily in the main memory and, optionally, persists associated context data such as session identifiers, timestamps, and user identifiers in a relational database management system such as a general-purpose relational database, or in a document-oriented database. The server treats this electronic data as raw text information and additional information.

The server applies natural language processing to the text information using the natural language processing library. The server loads a pre-trained language model (for example, an English model in spaCy) into the main memory, where the model is represented as a set of parameterized statistical structures such as tokenization rules, part-of-speech tagger weights, and named entity recognition weights. The server feeds the text information into the library, and the library converts the text into internal token objects, attaches part-of-speech tags, identifies dependency relations, and detects named entities. The server further performs higher-level data processing such as removing stop words, normalizing inflected forms to lemmas, and extracting key phrases using rule sets and statistical thresholds.

The server then constructs structured data that contains fields such as intent information, important word information, and target information. For intent information, the server may apply a separate classification module implemented using a machine learning framework such as scikit-learn, PyTorch, or TensorFlow. In one example, the server uses a feedforward neural network classifier that receives as input a feature vector derived from the token sequence. The feature vector may include, for example, a bag-of-words representation, term frequency-inverse document frequency values, or sentence embeddings obtained from a pre-trained transformer encoder. The neural network includes multiple layers with weight matrices and nonlinear activation functions such as rectified linear units. The server computes the output scores that correspond to intent categories, and normalizes these scores using a softmax function. The category with the highest probability is selected as the intent information, such as “delivery_issue.”

Simultaneously, the server determines important word information by computing statistics over the tokens, such as term frequency-inverse document frequency scores, or by applying attention weights derived from a transformer-based encoder. The server selects tokens or phrases whose scores exceed a threshold as important words, such as “package”, “arrived”, and “order.” The server also identifies target information such as a product name or an order concept by combining named entity labels and domain-specific pattern matching rules. The structured data is represented as a data object in memory, for example as a dictionary mapping field names to lists of tokens, category labels, and numerical scores.

Based on the structured data, the server determines a classification result of the inquiry and checks for missing information. The server maintains a classification rule set or model that maps intent categories to required additional information types. For example, if the intent is classified as “delivery_issue,” the server determines that an order identifier or tracking identifier is required. The server compares this requirement with the structured data and additional information that has already been obtained to detect whether such identifiers are present. If the identifiers are missing, the server sets a flag indicating missing information and records the type of additional information required.

The server next generates a prompt sentence to be supplied to the generative AI model. For this purpose, the server stores template information in the storage device. The template information defines patterns that describe how instructions, context information, and user inquiries are combined into a single textual prompt. A template may include placeholders for fields such as intent, missing information types, and the original inquiry text. The server retrieves a template appropriate for the classification result, then inserts the structured data and metadata into the template through string concatenation or a template engine.

In one example, the server generates the following prompt sentence:
“You are a customer support assistant for an online store. The user has reported a delivery problem. Analyze the following inquiry and generate a clear, polite, and actionable answer. Ask the user for the order ID if it is not provided, and explain how to check tracking information. Avoid making up specific order details. User inquiry: ‘My package has not arrived yet. What should I do?’”

In another example, the server generates a prompt sentence such as:
“Act as a customer support agent for an online service. The user is experiencing a delivery issue and may be missing an order identifier. Provide a concise and friendly explanation of the next steps and request any missing identifiers needed to investigate. User inquiry: ‘The item I ordered last week still hasn't arrived.’”

The server transmits the generated prompt sentence to the generative AI model using an external application programming interface. In one implementation, the generative AI model is a transformer-based neural network that is deployed on a remote computing system managed by a service provider. The model comprises multiple layers of self-attention and feedforward sublayers, with parameters (weights and biases) that have been learned during a pre-training phase on large text corpora. The model input is a sequence of tokens corresponding to the prompt sentence, converted into embedding vectors. The model performs matrix multiplications, non-linear activations, and attention weight computations across these vectors to produce a probability distribution over the next token at each step. The server specifies parameters such as maximum output length, temperature, and top-k or top-p sampling thresholds in the request.

The server sends a request message including the prompt sentence and the parameters through the communication interface, encoded as a structured format such as a JSON object. The server receives a response message that contains a response text generated by the generative AI model. The response text is typically a natural language sequence that addresses the user inquiry, for example: “We are sorry to hear that your package has not arrived. Please check the tracking information in your order history. If you cannot find the tracking number, please provide your order ID so that we can investigate further.”

The server applies post-processing to the response text. The server may execute a content inspection module that checks the response for prohibited terms, disallowed categories, or violations of internal policies using a combination of rule-based pattern matching and classification models. The server may adjust the length of the response by truncating or summarizing segments based on predetermined maximum character counts or sentence boundaries. The server may also convert the expression format, for instance by ensuring a consistent politeness level, by unifying terminology according to a domain-specific glossary, or by injecting line breaks or markup tags suitable for the target user interface. Additionally, the server can insert supplemental information such as links to help pages or short instructions specific to the service, resulting in a user-oriented response message.

The server transmits the user-oriented response message to the terminal over the communication network. The terminal receives the response message, parses the content, and updates the user interface to display the message to the user. The user views the response on the display and can decide whether the response was satisfactory. The user may supply feedback information by interacting with a feedback interface element on the terminal, such as selecting a rating value or entering an explanatory comment like “The answer helped me track my package.”

The terminal transmits the feedback information to the server as electronic data. The server receives the feedback information and stores it in association with the corresponding inquiry, the prompt sentence, and the response text. The associations are implemented using foreign keys in a relational database or using document references in a document database, thereby enabling consistent linkage between the stages of processing. The server aggregates feedback from multiple interactions by computing metrics such as average ratings per template, distribution of ratings per intent, or error indicators associated with specific phrasing patterns of prompt sentences.

The server analyzes the aggregated feedback using statistical analysis and machine learning. For example, the server may compute correlations between explicit instruction phrases in prompt sentences and resulting user satisfaction scores. The server may also train or update a model that predicts expected feedback quality based on features extracted from prompt sentences and structured data. These features can include, for example, the presence or absence of specific instructions, the number of explicit constraints imposed on the generative AI model, or the complexity of the user inquiry. By optimizing the model parameters using an error function such as cross-entropy or mean squared error, and updating weights through gradient-based optimization, the server refines its ability to select or generate prompt sentences likely to yield better responses.

The server updates the template information and generation conditions for prompt sentences based on the analysis result. In one embodiment, the server adjusts internal scores associated with template variants and preferentially selects templates that historically produced higher evaluation scores. In another embodiment, the server alters constraint parameters such as maximum output length, instruction wording, or required contextual elements to improve coherence and relevance. The server may also update classification rules or parameters of the intent identification model using the feedback as supervised labels, thereby improving the accuracy of mapping inquiries to categories.

Because the server explicitly transforms raw text inquiries into structured data, determines missing information types, and uses this structured representation to constrain and condition the generative AI model's input, the system improves computer functionality in several ways. The structured representation reduces ambiguity at the model input stage, which leads to more accurate and consistent outputs with shorter generation length, thus reducing processing time and computational load on the generative AI model. The explicit detection of missing information allows the server to instruct the model to request only necessary additional data, reducing the number of back-and-forth exchanges and network messages. The continuous adaptation of template information and classification parameters based on feedback enables the server to converge towards more efficient configurations, improving both response quality and resource utilization.

In contrast to manual or purely rule-based customer support processes, the server applies non-traditional processing flows tailored to the capabilities and limitations of large neural models. For instance, the server may deliberately simplify and normalize input language to reduce the dimensionality of the model's search space, and may insert explicit constraints such as “Avoid making up specific order details” to prevent hallucinations. These constraints are not simply human rules transcribed into software; rather, they are learned and refined based on empirical performance and are applied in a way that coordinates multiple computational modules, including the natural language processing library, the intent classifier, the prompt generator, and the model usage controller.

From a technical standpoint, the combination of structured pre-processing, model-aware prompt construction, and feedback-driven reconfiguration provides a specific computational architecture that modifies how a general-purpose computing device allocates memory, performs numerical operations, and schedules network communication. For instance, by predicting the likely usefulness of a generative model call and by reducing the length and complexity of prompts, the server reduces the number of tokens processed by the external neural network, thereby lowering the number of floating-point operations and reducing latency. Moreover, by using classified intents and structured fields, the server can cache responses or partially reuse past computations for similar inquiries, further reducing redundant computation.

Alternative embodiments are also contemplated. In another embodiment, the server executes the generative AI model locally on a specialized hardware accelerator, such as a graphical processing unit-based compute module, instead of calling an external service. In this case, the server stores the neural network parameters in local non-volatile storage, loads them into the memory at initialization, and performs matrix multiplications and non-linear operations using the accelerator's instruction set. The same structured data and prompt sentences are then fed into the locally executed model. In yet another embodiment, the server uses different types of generative models, such as encoder-decoder architectures or recurrent neural networks, provided that the input is in the form of a prompt sentence and the output is natural language text.

In a further variation, the terminal performs part of the pre-processing or post-processing. For example, the terminal may execute a lightweight on-device model to detect the language of the inquiry, or to apply display-specific formatting rules to the received response message. The server still performs the core structured analysis, prompt sentence generation, interaction with the generative AI model, and feedback-driven optimization. Such a distributed architecture can reduce server-side compute load and network payload, while maintaining the overall technical effect of improved response quality and efficiency.

In another embodiment, the server extends the structured data and template information to support multi-turn dialogs. The server maintains a dialog state object that includes a history of previous inquiries, response texts, and missing information flags. The server incorporates selected parts of this dialog state into the prompt sentence in a controlled manner, for example by including only the last few turns or by summarizing previous context. This selective inclusion is governed by rules that balance relevance and prompt length, thereby controlling computational cost and reducing the risk of context drift. Feedback on multi-turn dialogs is stored and analyzed similarly, and is used to adjust how much context to provide to the generative AI model in subsequent interactions.

Through these embodiments and variations, the server, the terminal, and the user cooperate in a technical process where the server's internal data structures, algorithms, and model control logic are designed not only to automate communication but to improve the operation of the computing system itself. The server restructures language input, orchestrates model usage, and continuously re-optimizes its own processing pipeline using feedback as learning data, thereby achieving improved accuracy, reduced latency, lower computational cost, and more effective data management compared to conventional systems that simply pass raw text between a user and a language model.

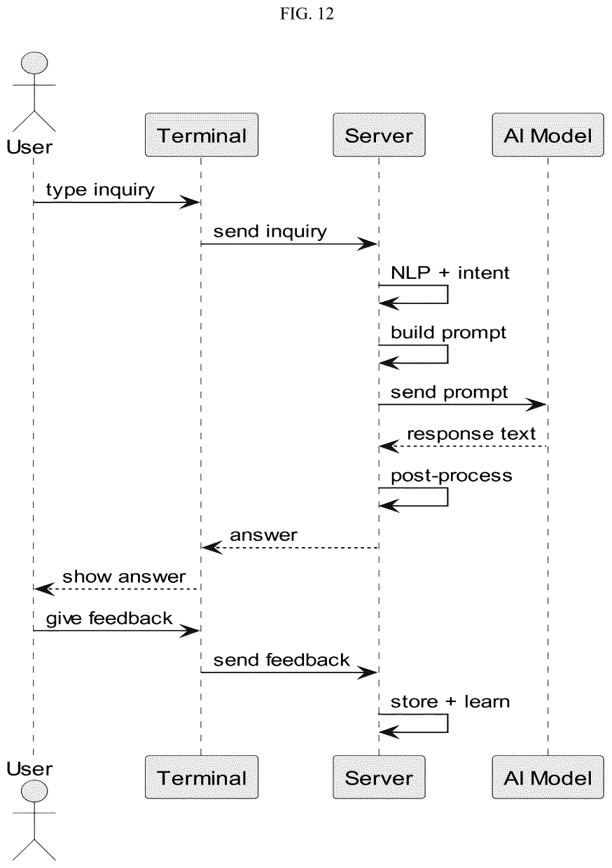

The following describes the processing flow using FIG. 12.

### Step 1:

The user inputs an inquiry on the terminal.

The terminal displays a text input field and a send button on a graphical user interface. The user types an inquiry sentence such as “My package has not arrived yet. What should I do?” into the input field and presses the send button. The terminal sets the inquiry text, a user identifier, a session identifier, and a timestamp as input data for transmission. The terminal then packages these values into a structured object and outputs a transmission-ready message toward the server.

### Step 2:

The terminal transmits the inquiry to the server via a communication network.

The terminal takes the structured object generated in Step 1 as input, serializes it into a request message according to a communication protocol such as HTTPS, and sends the message to a predetermined server endpoint. During this operation, the terminal performs data encoding (for example, UTF-8 encoding of the text) and inserts protocol headers. The output of this step is a network packet stream carrying the inquiry data addressed to the server.

### Step 3:

The server receives and validates the inquiry message.

The server uses a communication interface to accept the network packet stream from Step 2 as input. The server reassembles the packets into a complete request, decodes the message body, and extracts the inquiry text, user identifier, session identifier, and timestamp. The server then performs validation by checking that mandatory fields exist and that the data types and lengths satisfy predefined constraints. If the validation succeeds, the server outputs a validated inquiry object stored in working memory; if the validation fails, the server outputs an error response and terminates processing for this request.

### Step 4:

The server normalizes and cleans the inquiry text.

The server takes the validated inquiry object as input and focuses on the text field. The server converts the text to a unified character encoding, normalizes Unicode sequences, and removes control characters. The server replaces multiple whitespace characters with single spaces, trims leading and trailing spaces, and optionally converts full-width characters to half-width characters. Through these string operations, the server transforms the raw text into a normalized text string. The server outputs an updated inquiry object that includes the normalized text as a field.

### Step 5:

The server performs tokenization and basic linguistic analysis using a natural language processing library.

The server uses the normalized text from Step 4 as input and applies a natural language processing library such as spaCy or NLTK. The server invokes the library's parsing function, which divides the text into tokens, assigns part-of-speech tags, and generates dependency relations. Internally, the library performs rule-based and statistical segmentation and tagging operations. The server receives as output a linguistic analysis structure, such as a document object containing tokens, tags, syntactic dependencies, and sentence boundaries.

### Step 6:

The server extracts important words and target information.

The server takes the linguistic analysis structure from Step 5 as input. The server iterates over the tokens and sentences, removes stop words based on a predefined stop-word list, and lemmatizes remaining tokens to standard forms. The server computes metrics such as term frequency or term frequency-inverse document frequency for tokens and phrases. Based on these metrics and threshold values, the server selects important words. Additionally, the server applies named entity recognition results from the analysis structure and pattern matching rules to detect target entities such as product references or order concepts. The output is a structured data object containing lists of important words and target information associated with the inquiry.

### Step 7:

The server infers intent and determines required additional information.

The server uses the structured data from Step 6, including tokens, important words, and target information, as input to an intent classification component. The server constructs a feature vector, for example by encoding word frequencies, embedding vectors, and entity types. The server feeds this vector into an intent classifier model such as a neural network, which performs matrix multiplications and nonlinear activations to produce scores for each possible intent label. The server selects the highest scoring label, such as “delivery_issue,” as the intent. Next, the server consults a rule table that maps each intent label to required additional information types (for example, “order_id” for “delivery_issue”). By comparing this requirement with the presence or absence of such fields in the structured data and additional information, the server determines which types of information are missing. The output is an extended structured data object containing intent information and a list of required additional information types.

### Step 8:

The server selects a template and generates a prompt sentence.

The server uses the extended structured data object from Step 7 as input and queries a template store in a storage device. The server selects a template associated with the inferred intent and, optionally, with specific missing information types. The template contains fixed instruction phrases and placeholders for intent labels, required information types, and the original inquiry text. The server fills the placeholders by inserting the intent description, a textual mention of missing information (for example, “order ID”), and the normalized inquiry text. The data processing in this step consists of string concatenation, placeholder substitution, and formatting operations. The output is a complete prompt sentence such as: “You are a customer support assistant for an online store. The user has reported a delivery problem. Analyze the following inquiry and generate a clear, polite, and actionable answer. Ask the user for the order ID if it is not provided, and explain how to check tracking information. Avoid making up specific order details. User inquiry: ‘My package has not arrived yet. What should I do?’”

### Step 9:

The server configures parameters and sends the prompt sentence to the generative AI model.

The server takes the prompt sentence from Step 8 as input and combines it with model control parameters such as maximum token count, temperature, and sampling thresholds. The server constructs a request object for a generative AI model API, containing the prompt, the model identifier, and the control parameters. The server serializes this object into a request message and uses the communication interface to transmit the message to a remote generative AI model endpoint over a secure protocol. The output of this step is a network request carrying the prompt sentence and model parameters to the generative AI model.

### Step 10:

The server receives and extracts the generated response text from the generative AI model.

The server uses the network response from the generative AI model as input. The server parses the response message, decodes the body, and extracts the generated natural language text from a designated field. The server optionally checks for error indicators or incomplete output and may handle such situations by applying fallback rules. The primary data processing in this step consists of parsing structured response data and selecting the text segment that represents the generated answer. The output is a raw response text produced by the generative AI model in response to the prompt sentence.

### Step 11:

The server post-processes the response text and constructs a user-oriented response message.

The server takes the raw response text from Step 10 as input and passes it to a post-processing module. The server performs content inspection by checking the text against rule-based filters and classification models to detect inappropriate or off-topic content. The server then adjusts the length by truncating or summarizing text segments that exceed preset limits, while preserving key information. The server converts the expression format, for example by standardizing salutations, politeness level, and terminology according to a domain-specific style guide. If needed, the server appends structured supplemental information, such as a short instruction sentence or a reference link, by concatenating additional text. The output is a finalized response message tailored for presentation to the user.

### Step 12:

The server sends the user-oriented response message to the terminal.

The server uses the finalized response message from Step 11 as input and encapsulates it in a response object together with metadata such as intent, suggested actions, and identifiers. The server serializes the response object into a protocol-compliant message and sends it via the communication interface to the terminal over the communication network. The output is a server-to-terminal network response that carries the response message and associated metadata.

### Step 13:

The terminal receives and displays the response message to the user.

The terminal uses the network response from Step 12 as input. The terminal decodes the received message, parses the response object, and extracts the response text and any suggested actions. The terminal updates its graphical user interface, for example by rendering the text in a chat bubble or a dedicated response area, and by creating interactive elements such as buttons for suggested actions. The data processing here includes parsing structured fields, mapping them to UI components, and writing text to a frame buffer for display. The output is a visual presentation of the response message on the terminal's display, accessible to the user.

### Step 14:

The user evaluates the response and inputs feedback on the terminal.

The user reads the displayed response message and determines its usefulness or correctness. The terminal presents feedback controls such as a rating bar, thumbs-up and thumbs-down buttons, and a text box for comments. The user manipulates these controls to provide feedback, for example by selecting a high rating and entering a comment such as “The answer helped me find my tracking number.” The terminal collects this feedback data as input for the next step. The output of this step is a feedback object containing evaluation values and comment text.

Step 15:

The terminal transmits the feedback information to the server.

The terminal takes the feedback object from Step 14 as input, attaches identifiers such as inquiry ID, response ID, and timestamp, and constructs a feedback request. The terminal serializes the request into a protocol-compliant message and sends it to a feedback endpoint on the server via the communication network. The output is a network packet stream that carries the structured feedback information to the server.

### Step 16:

The server stores and associates the feedback information with internal records.

The server receives the feedback request from Step 15 as input. The server validates the rating values and comment length, then locates the corresponding inquiry, prompt sentence, and response text records using the included identifiers. The server writes a new feedback record into a storage system and sets foreign keys or reference fields to link it with the related inquiry and response data. The data processing includes database insert operations, index updates, and referential integrity checks. The output is a persistent feedback dataset associated with each interaction instance.

### Step 17:

The server aggregates feedback data and computes performance metrics.

The server takes multiple feedback records from the storage system as input. The server groups the records by attributes such as intent category, template identifier, or prompt configuration. For each group, the server computes statistics, including average rating, distribution of scores, and frequency of specific comment keywords. The server may also build feature vectors representing template patterns and compute correlations between features and feedback metrics. The output is an aggregated performance profile that characterizes how different prompt sentences, templates, and processing configurations perform with respect to user feedback.

### Step 18:

The server updates template information and model control parameters based on analysis results.

The server uses the aggregated performance profile from Step 17 as input. The server identifies template patterns and instruction phrases associated with higher performance and increases their selection priority by adjusting internal weight values. Conversely, the server reduces the priority or deactivates underperforming templates. The server may also update control parameters for the generative AI model, such as reducing maximum output length for intents that do not require long explanations, or adding explicit constraints into templates to reduce known error patterns. The server writes updated template definitions and parameter sets back to the storage system. The output is a revised set of template information and model control parameters that will be used for subsequent prompt sentence generation.

### Step 19:

The server refines intent classification rules and identification model parameters using feedback.

The server takes feedback records and their associated structured data as input. The server interprets positive and negative evaluations as labels indicating the suitability of the inferred intent or response. The server constructs training examples by pairing feature vectors (derived from tokens, important words, and target information) with updated ground-truth signals derived from feedback. The server performs a training or fine-tuning process on the intent classification model, minimizing an error function by adjusting weight parameters through gradient-based optimization. The result is an updated classification model that is better aligned with user preferences and actual resolution success. The output is an updated intent identification model and, if applicable, revised rule thresholds, which are then stored and used in future intent inference operations.

### Step 20:

The server applies the updated configurations in subsequent interactions to improve system behavior.

The server uses the revised template information, model control parameters, and intent classification model from Steps 18 and 19 as input during future inquiry processing. When a new inquiry arrives, the server automatically uses the updated intent model to classify the inquiry, selects templates according to updated priorities, and sets generative AI model parameters based on the latest configuration. This causes subsequent prompt sentences to be more precisely tailored and model calls to be more efficient. The output of this step is an ongoing improvement in accuracy, latency, and resource usage in future processing cycles, resulting from the integration of prior feedback into the computational pipeline.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented systems that generate natural language responses using generative AI models typically construct prompts directly from user queries or from manually defined templates. In such systems, user attribute information, including demographic information and usage history information stored in backend data stores, is either not used at all or is only used in a coarse and static manner. As a result, the computer system fails to accurately model or imitate user-specific behavior patterns, and the output of the generative AI model remains generic and weakly personalized.

From a computer technology standpoint, existing architectures generally treat user attribute data and prompt generation logic as loosely coupled components, with limited automated data preprocessing. Raw attribute data is often stored in heterogeneous formats, such as mixed data types and unnormalized categorical fields, which are not directly compatible with the input requirements of generative AI models that operate over natural language tokens. When such unprocessed or poorly processed data is used, the system incurs additional computation at the application layer, suffers from inefficient use of processing and communication resources, and may produce unstable or low-quality prompts that reduce the determinism and reproducibility of model behavior.

Furthermore, conventional systems lack a standardized, machine-executable pipeline that transforms structured attribute information into semantically rich, context-aware prompt sentences. These systems do not systematically encode attributes such as age categories, gender categories, and usage history categories into a normalized intermediate representation and then into a natural language description with explicit behavioral conditions and output format constraints. Consequently, the generative AI model receives under-specified or ambiguous instructions, which leads to responses that fail to exploit the full informational content of the user attribute data and diminishes the technical effectiveness of the underlying computing infrastructure.

There is therefore a need for an improved computer-implemented technique that programmatically acquires user attribute information from a storage device, preprocesses the information into a form suitable for prompt generation, and constructs prompt sentences that explicitly reflect user attributes and behavioral conditions. Such a technique should improve the interaction between the application logic and the generative AI model, enhance utilization of computational resources by reducing ad hoc processing on the client side, and increase the consistency, specificity, and personalization of the generated behavior simulations.

The specific processing by the specific processing unit 290 of the data processing device 12 in Example 2 is realized by the following means.

The present invention provides a server comprising a processor configured to acquire, from a storage device, attribute information related to a user based on identification information of the user, preprocess the acquired attribute information by performing numerical conversion processing and encoding processing to generate preprocessed data suitable as input to a generative AI model, generate, based on the preprocessed data, a natural language description reflecting attributes including at least an age category, a gender category, and a usage history category, add to the natural language description conditions regarding imitation or reproduction of user behavior and conditions regarding an output format, thereby generating a prompt sentence for input to the generative AI model, input, via a communication path, the prompt sentence to the generative AI model and obtain, from the generative AI model, a natural language text representing a user behavior pattern generated based on the prompt sentence, and convert the obtained natural language text into display data and transmit the display data, via the communication path, to a terminal device including a display device. This enables a computer-centered improvement in which the server automatically transforms heterogeneous user attribute data into a normalized intermediate representation and into a structured prompt sentence, thereby allowing the generative AI model to produce more precise and personalized behavior simulations, reducing unnecessary application-side processing, and improving overall system efficiency, scalability, and response quality in a technical sense.

The term “processor” refers to a hardware-based information processing unit, such as a central processing unit or a processing core, configured to execute instructions of one or more programs to perform data processing operations described in the present specification.

The term “storage device” refers to a hardware component or subsystem, such as a memory device or a non-volatile storage device, configured to store data including user attribute information, identification information, and program data in a machine-readable form.

The term “identification information” refers to data that uniquely or quasi-uniquely distinguishes a user from other users, such as an identifier, an account number, or another reference value used to retrieve user-related information.

The term “attribute information” refers to data representing characteristics associated with a user, including but not limited to demographic information, behavioral information, and usage history information stored in association with the user.

The term “preprocessing” refers to a series of data transformation operations performed on raw attribute information to convert the raw attribute information into a format suitable for subsequent processing by a program or model, including at least numerical conversion processing and encoding processing.

The term “numerical conversion processing” refers to an operation of converting data expressed in a non-numerical representation, such as a character string, into a numerical representation, such as an integer or floating-point value, that is suitable for computational processing.

The term “encoding processing” refers to an operation of transforming categorical or symbolic data into a structured representation, such as a numeric code, vector, or one-hot representation, that can be processed by a computer program or a machine learning model.

The term “preprocessed data” refers to data obtained by applying preprocessing, including numerical conversion processing and encoding processing, to raw attribute information, and which is formatted for use as input to subsequent processing modules, including a generative AI model.

The term “generative AI model” refers to an artificial intelligence model, such as a machine learning model or a neural network model, configured to generate new data, including natural language text, based on input data or instructions.

The term “natural language description” refers to text expressed in a human language and generated by a program based on attribute information, the text being structured so as to be understandable by both a human and a generative AI model.

The term “age category” refers to a classification or grouping of users based on age-related information, such as a decade-based range, and derived from age values included in attribute information.

The term “gender category” refers to a classification or grouping of users based on gender-related information, derived from gender values included in attribute information.

The term “usage history category” refers to a classification or grouping of users based on past usage or behavior records, such as purchase history, browsing history, or content consumption history, derived from usage history information included in attribute information.

The term “conditions regarding imitation or reproduction of user behavior” refers to constraints or specifications included in a prompt or instruction that define how a generative AI model should simulate, mimic, or reproduce user behavior patterns.

The term “conditions regarding an output format” refers to constraints or specifications included in a prompt or instruction that define the structural aspects of the output generated by a model, such as a time series format, an itemized format, or a specified level of detail.

The term “prompt sentence” refers to a natural language instruction or query, generated by the processor, for input to a generative AI model, the instruction or query specifying a task, context, or constraints to guide the output produced by the model.

The term “communication path” refers to a logical or physical communication channel, such as a network connection or data link, that enables data transmission between the server, the generative AI model, and one or more terminal devices.

The term “natural language text” refers to text output generated by a generative AI model in a human language, representing, in the context of the present invention, a user behavior pattern or scenario.

The term “user behavior pattern” refers to a sequence or structure of actions, decisions, or events that characterize how a user typically behaves in a given context, such as online activities, purchasing behavior, or browsing behavior.

The term “display data” refers to data formatted by the processor for presentation on a display device, such as a character string, a structured text object, or a markup-based document suitable for rendering by a terminal device.

The term “terminal device” refers to a computing apparatus, such as a personal computer, a mobile device, or a display-equipped client device, configured to communicate with the server and to present display data to a user.

The term “display device” refers to a hardware component, such as a screen or monitor, configured to visually present information, including display data, to a user.

In one embodiment, a server includes a processor, a storage device, a communication interface, and a memory storing one or more programs that, when executed by the processor, cause the server to perform the functions described below. The server operates in communication with one or more terminal devices via a communication network such as a packet-switched network. The terminal includes a display device and an input device and executes a client application or a browser to communicate with the server. A user operates the terminal to request generation and display of behavior simulations.

The server stores, in the storage device, user identification information and attribute information associated with each user. The attribute information includes at least age information, gender information, and usage history information. The storage device is implemented, for example, by a relational database system executing on a storage controller and a non-volatile storage medium. The server stores the attribute information in predefined tables having fields for numeric values and categorical values so that the processor can efficiently retrieve and preprocess these fields.

The server executes a program implemented in a general-purpose programming language such as Python on an operating system executing on a processor architecture such as an x86-compatible central processing unit. The server uses software libraries for data manipulation and numerical computation, including a tabular data manipulation library (for example, a library of the type that provides DataFrame structures), a numerical computation library that provides array operations, and a machine learning utility library that provides encoding and transformation functions. By using these software components, the server converts heterogeneous attribute records into a normalized intermediate representation suitable as a basis for generating a prompt sentence for a generative AI model.

The server uses a generative AI model implemented as a trained neural network language model executing on one or more accelerator devices such as graphics processing units. The generative AI model includes multiple stacked layers of a sequence-processing architecture, each layer comprising an attention mechanism and feedforward computation units. The generative AI model is trained in advance on large corpora of natural language text so that the model learns parameters (weights and biases) that define a probability distribution over token sequences. During training, the model minimizes an objective function such as cross-entropy loss between predicted token distributions and actual tokens, and updates weights by an optimization algorithm such as stochastic gradient descent with adaptive learning rate. The model parameterization and training procedure provide the server with a deterministic mapping from input tokens representing the prompt sentence to output tokens representing a natural language text.

The server uses specific data structures to represent preprocessed attribute information. The server represents each user by a structured record including numeric fields for age and encoded gender category, and a binary vector for usage history categories. The server derives the binary vector by encoding each possible usage history category (for example, product types or content types) as a position in the vector and assigning a value of one when the user has exhibited that usage and a value of zero otherwise. This structured representation allows the server to perform constant-time checks and efficient aggregation over usage patterns, thereby improving computation efficiency compared to processing raw textual logs.

The server programmatically converts these structured representations into natural language descriptors. For example, the server maps age values into discrete age categories such as “in his 30s” or “in her 20 s” based on predetermined numeric ranges. The server maps encoded gender values into textual expressions such as “male user” or “female user.” The server analyzes the binary usage history vector to identify dominant categories by applying selection criteria such as frequency thresholds or preference scores computed from historical counts, thereby reducing the dimensionality of the information that will be embedded in the prompt sentence. This selection avoids overloading the generative AI model with irrelevant details and leads to more focused and computationally efficient generation.

The server then constructs a prompt sentence in natural language by using a rule-based template mechanism that differs from simple concatenation of user input. The server uses templates that specify sentence structures and predefined slots for attribute-derived phrases and behavioral conditions. For example, the server may generate a prompt sentence such as: “Simulate the one-week online shopping behavior of a male user in his 30s who frequently purchases electronics, books, and games. For each day, describe which websites he visits, which product categories he browses, which items he adds to his cart, and which items he finally purchases. Include a short explanation for his main decisions.”

In another example, the server may generate:
“Simulate the weekend online behavior of a female user in her 20s who often buys cosmetics and fashion items. Start from her social media browsing, then describe how she discovers products, compares different brands, adds items to her cart, and decides what to purchase. Focus on detailed actions and motivations.”

In still another example, the server may generate:
“For a user in his 40 s who regularly buys business books and productivity tools, simulate his typical monthly online shopping pattern. Include search queries he might use, comparison steps between products, and the final selection process. Present the result as a chronological list of actions with brief reasoning.”

The server constructs these prompt sentences automatically based on the attribute-derived descriptors and predetermined rules that encode how to place age categories, gender categories, and usage history categories into specific grammatical positions. The server further embeds explicit conditions regarding the period of behavior to be simulated (for example, “one day,” “one week,” or “one month”), the desired level of detail (for example, “brief summary,” “detailed step-by-step description”), and the structural form of the output (for example, “chronological list,” “day-by-day sections,” or “itemized format”). This rule-based construction defines a non-conventional, computer-specific procedure that configures the input token sequence to the generative AI model in a way that is optimized for the capabilities and constraints of the model architecture.

The server transmits the constructed prompt sentence to the generative AI model via the communication interface by forming a request message that encodes the prompt sentence in a tokenized representation. The server and the generative AI model communicate over a network protocol such as a secure application layer protocol. The server may control generation parameters of the model, including temperature, maximum output length, and sampling strategy, to balance diversity and determinism according to system requirements. By adjusting these parameters in combination with the structured prompt sentence, the server reduces the variance in output quality and improves reproducibility across repeated invocations with similar attribute information.

The server receives, from the generative AI model, an output token sequence representing the generated natural language text. The generative AI model produces this output by iteratively applying its attention mechanisms and feedforward layers over the internal token embeddings. Each layer computes context-aware representations by performing weighted summations over other token embeddings, where the weights are determined by learned attention parameters. Because the prompt sentence is constructed to encode structured attribute information and explicit behavioral constraints, the attention mechanisms within the model allocate more weight to relevant tokens that encode age categories, gender categories, and usage history categories. As a result, the generated text more accurately reflects the user-specific behavior pattern and reduces irrelevant or generic content. This interaction between the tailored prompt structure and the model architecture improves computational efficiency by focusing processing on salient features of the input sequence.

The server converts the generated natural language text into display data suitable for presentation on the terminal. The server may segment the text into sections based on temporal markers or list markers, insert markup tags or metadata to indicate different logical parts (for example, “Day 1,” “Day 2,” “Key purchase,” “Reasoning”), and compress the text if necessary to reduce network transmission size. This conversion improves communication efficiency by reducing redundancy and enabling incremental or paginated transfer to the terminal.

The terminal receives the display data, decodes it, and renders the content on the display device. The terminal executes a client application or browser that parses the structured text and presents it in a UI layout optimized for readability, such as separate panels for each day of the simulated period, or expandable sections for reasoning details. The user views the rendered behavior simulation, and may input further instructions or modifications. The terminal transforms user interactions into structured requests that reference particular simulation parameters or attribute modifications, and transmits these requests back to the server.

The server, upon receiving additional requests from the terminal, is able to modify attribute information or override parameters such as time period and level of detail, and to regenerate a new prompt sentence and a new behavior simulation in the same standardized pipeline. This iterative loop allows the server to reuse the same preprocessed attribute representation and prompt construction logic, thereby avoiding redundant computations and reducing the overall processing time required to adapt simulations to new conditions.

In alternative embodiments, the server may employ different encoding schemes for attribute information. For example, the server may represent age and usage history as continuous-valued feature vectors normalized to specific ranges, or may apply dimensionality reduction techniques to compress high-dimensional usage history into lower-dimensional embeddings. These alternative feature encodings may be combined with different prompt templates that emphasize different aspects of user behavior, such as temporal patterns, category preferences, or response to external events. In still other embodiments, the server may use a generative AI model with a different neural network architecture, such as a recurrent neural network, a convolutional sequence model, or a hybrid architecture that combines multiple attention heads with specialized sub-networks for behavioral reasoning.

In all of these embodiments, the server implements a structured data flow that begins with attribute acquisition from a storage device, proceeds through machine-executable preprocessing and encoding operations, and culminates in the construction of a prompt sentence that is specifically tailored to the architecture and training characteristics of the generative AI model. By pre-aligning the data representation with the model's token-based interface, the server reduces the need for ad hoc mapping operations at runtime and decreases the computational overhead associated with generic, unstructured prompts. This structured pipeline leads to faster inference times, as the generative AI model can more quickly converge to relevant output tokens when the prompt sentence encodes key attributes in predictable positions and formats.

Furthermore, the server improves accuracy and consistency of the generated behavior simulations by imposing explicit structural constraints in the prompt sentence. These constraints reduce the search space of possible outputs and guide the internal decoding process of the generative AI model toward sequences that match the desired output form. This not only increases the relevance of the generated text for each user profile but also stabilizes the model output against minor fluctuations in the input or random sampling. Such stability and predictability are particularly important in large-scale deployments where many users interact with the system concurrently.

The technical effect of these configurations is not limited to simple automation of manual behavior description. Instead, the server implements a non-conventional interaction pattern between the attribute database, the preprocessing module, the prompt construction module, and the generative AI model. The server's ability to automatically convert heterogeneous attribute information into a structured prompt sentence designed for the architecture of the generative AI model improves the utilization of computing resources, reduces network load by avoiding unnecessary back-and-forth refinement, and enhances the precision and personalization of the generated outputs. These improvements constitute an enhancement of computer technology itself, by optimizing the entire end-to-end pipeline from data storage through model inference to terminal display.

In some embodiments, the server additionally logs attribute-derived prompt sentences, associated model parameters, and generated outputs in a structured log store. This log store is indexed for efficient retrieval and allows the server to evaluate error rates and quality metrics such as coverage of specified behavior conditions and adherence to specified output structures. The server may use these logs to refine its template rules and attribute transformation thresholds, thereby iteratively improving the performance of the pipeline in a data-driven manner. This feedback loop is implemented as a technical mechanism that adjusts system parameters based on observed outcomes rather than as a mere business process.

The embodiments described above are illustrative and non-limiting. The server may be implemented using different combinations of hardware and software components suitable for executing the described functions. The terminal may be a mobile device, a desktop device, or any computing apparatus with a display and communication capabilities. The generative AI model may be hosted by the same computing facility as the server or by a separate computing facility accessed via the network. Variations in the specific encoding schemes, prompt templates, and neural network architectures are encompassed within the scope defined by the claims, so long as the system uses attribute-based preprocessing and structured prompt sentence generation to improve the operation of the generative AI model and the computing system as a whole.

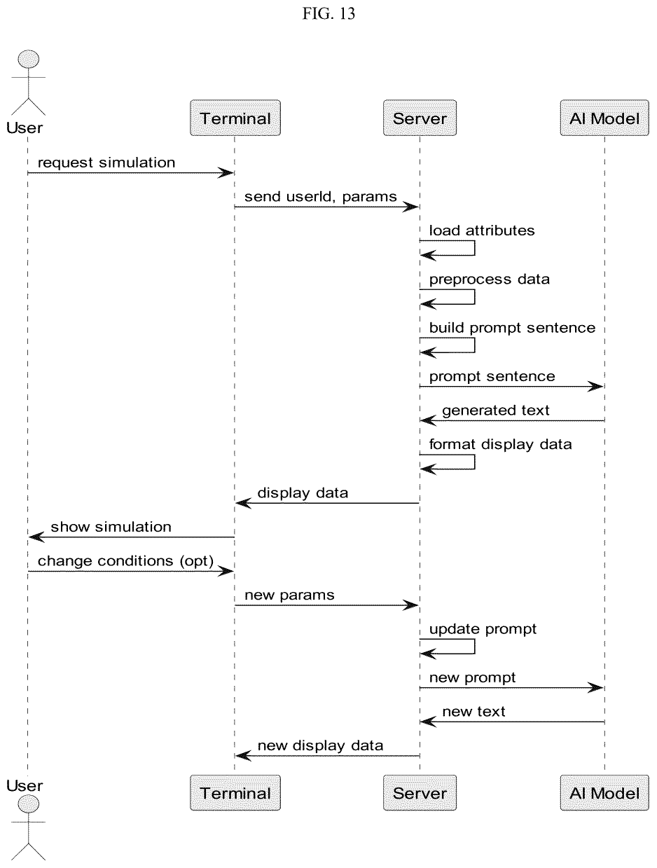

The following describes the processing flow using FIG. 13.

### Step 1:

The terminal sends a request to the server including user identification information.

The terminal uses a communication module to construct a request message that contains a user identifier as input (for example, a user ID string). The terminal transmits this message over a network to the server. The output of this step is a network request received by the server that specifies which user's attribute information should be processed.

### Step 2:

The server acquires attribute information from a storage device based on the user identification information.

The server uses the received user identifier as input and issues a retrieval operation to a storage device, such as a relational database system. The server executes a query that selects age information, gender information, and usage history information associated with the user identifier. The server converts the returned records into an internal data structure, for example, a record with fields for age (string or numeric), gender (string), and usage history (string list or coded sequence). The output of this step is raw attribute information associated with the user.

### Step 3:

The server converts the raw attribute information into a structured data record.

The server uses the raw attribute information as input and parses each field to align it with predefined schema fields. The server strips extraneous characters, normalizes encodings, splits concatenated strings such as comma-separated usage lists, and assigns each parsed value to a corresponding element in a structured record. The output of this step is a structured user record in which each attribute is placed into a dedicated field with a consistent representation.

### Step 4:

The server performs numerical conversion processing on the structured data.

The server uses the structured user record as input and converts non-numeric fields that represent numeric concepts into numeric values. For example, the server converts an age string into an integer and may compute derived numerical features such as normalized age by scaling the age value to a predetermined numeric range. The server may also replace categorical gender labels with numeric codes according to a mapping table. The output of this step is a numerically enhanced record in which age and other numeric attributes are represented as machine-processable numeric values.

### Step 5:

The server performs encoding processing on categorical elements of the structured data.

The server uses the numerically enhanced record as input and applies encoding algorithms to categorical attributes such as gender and usage history categories. For gender, the server maps each category label to a unique numeric code. For usage history, the server identifies distinct category values (for example, product types) and generates a binary vector in which each position corresponds to a category and indicates whether the user has interacted with that category. The server may apply one-hot encoding or multi-hot encoding depending on whether multiple categories can be active simultaneously. The output of this step is preprocessed data containing numeric and encoded vectors representing the user's attributes.

### Step 6:

The server derives higher-level attribute categories from the preprocessed data.

The server uses the preprocessed data as input and computes aggregate or grouped attributes. The server maps the numeric age value into an age category (for example, 30-39 mapped to “in his 30 s” or “in her 30 s”), maps the encoded gender code into a textual gender expression (for example, “male user” or “female user”), and analyzes the usage history vector to select dominant usage categories based on frequency or weight thresholds. The server ranks categories according to usage counts or scores and selects top categories for description. The output of this step is a set of derived attribute descriptors including an age category label, a gender descriptor, and a list of key usage categories.

### Step 7:

The server generates a natural language description from the derived attribute descriptors.

The server uses the derived attribute descriptors as input and constructs descriptive phrases in a human language. The server inserts the age category and gender descriptor into predefined phrase patterns and joins the selected usage categories with conjunctions to form a coherent expression of user interests. For example, the server may generate a phrase such as “a male user in his 30s who frequently purchases electronics, books, and games.” The output of this step is a natural language description that summarizes the user's attributes.

### Step 8:

The server adds behavioral conditions and output format conditions to construct a prompt sentence.

The server uses the natural language description as input and appends explicit conditions regarding behavior simulation and output structure. The server selects a time span (for example, one day, one week, or one month), a required detail level, and a structural format (for example, chronological or itemized) based on system configuration or user request. The server then composes a complete prompt sentence by embedding the description and conditions into a template. For example, the server may generate the following prompt sentence as output:
“Simulate the one-week online shopping behavior of a male user in his 30s who frequently purchases electronics, books, and games. For each day, describe which websites he visits, which product categories he browses, which items he adds to his cart, and which items he finally purchases. Include a short explanation for his main decisions.”

### Step 9:

The server transmits the prompt sentence to a generative AI model and configures model parameters.

The server uses the prompt sentence as input and forms a request to the generative AI model via a communication interface. The server specifies generation parameters such as maximum length, randomness level, and decoding method. The server converts the prompt sentence into a tokenized form compatible with the generative AI model's input layer and sends this token sequence together with the parameters to the model execution environment. The output of this step is a model invocation request that initiates text generation based on the structured prompt sentence.

### Step 10:

The server obtains a generated natural language text representing a user behavior pattern from the generative AI model.

The server uses the model invocation request as input and receives, from the generative AI model, an output token sequence that has been decoded as natural language text. The generative AI model internally applies its neural network layers to compute attention-weighted representations of tokens in the prompt and to predict successive tokens that complete the requested behavior scenario. The server reconstructs the textual output from the token sequence and stores it as a generated behavior description. The output of this step is a complete natural language text that simulates the user's behavior pattern in accordance with the prompt sentence.

### Step 11:

The server structures and formats the generated natural language text as display data.

The server uses the generated natural language text as input and parses the text to identify logical segments such as days, actions, and reasoning explanations. The server may detect headings, bullet-like structures, or temporal markers and insert formatting markers or metadata for each segment. The server then organizes the text into a data structure suitable for rendering by the terminal, such as sections labeled by day or by action type. The output of this step is display data that maintains the content of the generated text while adding structure to support efficient rendering and navigation.

### Step 12:

The server transmits the display data to the terminal over a communication path.

The server uses the structured display data as input and serializes it into a transferable representation. The server encapsulates this representation in a response message and sends the message to the terminal via the communication interface. The server may compress the data or segment it into multiple parts to optimize network utilization. The output of this step is a response received by the terminal that contains the display data representing the simulated user behavior.

### Step 13:

The terminal renders the display data on a display device for the user.

The terminal uses the received display data as input and interprets the structural markers or metadata to lay out the content on a screen. The terminal generates visual components such as text blocks, headings, and scrollable sections, and draws them using a rendering engine. The terminal may allocate separate regions for different days, highlight key actions such as purchases, and provide controls for expanding or collapsing detailed reasoning sections. The output of this step is a visual presentation of the simulated behavior on the display device.

### Step 14:

The user reviews the displayed behavior simulation and optionally modifies conditions.

The user uses the displayed content as input to assess whether the behavior simulation meets the user's needs. The user may operate input controls on the terminal to change parameters such as the time period, level of detail, or focus categories (for example, limiting to certain product types). The terminal converts the user's interactions into a new request that includes updated conditions and sends this request to the server. The output of this step is updated request information that can trigger another execution of the processing flow with modified inputs.

### Step 15:

The server updates simulation conditions and regenerates a new prompt sentence based on the updated request.

The server uses the updated request information as input and adjusts internal parameters, such as the behavior period or category filters, without necessarily re-reading all attribute information from the storage device unless changes require it. The server reuses the preprocessed attribute data or recomputes it as necessary, recomputes derived attribute descriptors if some attributes are overridden, and constructs a new natural language description. The server then generates a new prompt sentence that reflects the updated conditions, for example:
“Simulate the one-day online shopping behavior of a female user in her 20s who mainly purchases cosmetics and fashion accessories. Describe the browsing flow from social media to e-commerce sites and explain the reasons for each purchase decision.”

The output of this step is an updated prompt sentence that the server can send again to the generative AI model to produce a revised simulation.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented question answering and help systems typically apply natural language processing to user inquiries and directly generate responses using a language model based only on the current text input. Such systems suffer from several technical limitations.

First, conventional systems often fail to efficiently incorporate structured user context, including attribute information and usage history, into the response generation pipeline. The absence of an integrated mechanism for generating and managing context-rich prompt sentences for a generative AI model causes the model to operate on incomplete state information, which degrades the relevance and accuracy of the generated responses. As a result, the computing resources consumed by the generative model are not effectively translated into improved output quality.

Second, known systems generally treat emotional aspects of the user input as noise or ignore them entirely, and thus lack a low-latency mechanism at the processor level to derive emotion information from text and to adapt both prompts and responses accordingly. Without an integrated emotion analysis feedback loop, the system cannot systematically modify the behavior of the generative AI model based on detected negative or positive emotional states. This leads to inefficient use of inference cycles, because many generated outputs fail to address the real cause of user dissatisfaction and must be followed by additional interactions.

Third, existing solutions for handling new functions or new services are largely reactive. Systems typically wait until actual user inquiries are accumulated and then manually construct frequently asked questions and documentation. This reactive pattern burdens processing resources over time, because the system repeatedly processes similar queries that could have been anticipated and pre-computed. Moreover, conventional architectures do not provide a unified mechanism for feeding operation screen information and guidance information into a generative AI model via structured prompt sentences in order to generate assumed question information before release. As a consequence, server-side caching, content preparation, and model-guided optimization of guides and FAQs cannot be systematically performed.

Fourth, in many architectures, the prompt engineering logic for generative AI models is external to the main processing pipeline and is often manually designed, which prevents dynamic optimization based on logs of model inputs and outputs and user operation histories. There is no integrated data flow in which prompt sentences, model outputs, and user behavior are stored and then used to update emotion analysis and prompt generation algorithms. This disjoint design limits the system's ability to self-improve over time and results in suboptimal utilization of processing resources and network bandwidth.

Accordingly, there is a need for an improved computer-implemented system that: (i) transforms raw user inquiry information into structured information and user characteristic information in a unified pipeline; (ii) derives and stores emotion information and associates it with user profiles; (iii) automatically generates and adapts prompt sentences for a generative AI model that encode user attributes, usage history, emotion state, and new function or service context; (iv) uses the generative AI model not only to answer current inquiries but also to generate assumed question information and improved guidance information for new features; and (v) logs and exploits prompt sentences, model outputs, and user operation histories to update the underlying analysis and prompt generation processes. Such a system would technically improve the way a server processor orchestrates language processing, emotion analysis, prompt generation, and generative inference, thereby enhancing the efficiency, adaptability, and robustness of computer-based support and guidance functions.

The specific processing by the specific processing unit 290 of the data processing device 12 in Application Example 2 is realized by the following means.

The present invention provides a server comprising a processor configured to acquire inquiry information transmitted from a user, acquire the inquiry information as character string information by using a language processing technique, and convert the character string information into structured information having a semantic structure by performing word segmentation processing and syntactic analysis processing on the character string information; to acquire, based on the structured information and identification information for identifying the user, attribute information and past usage history information associated with the identification information, and generate user characteristic information including the attribute information and the usage history information; to perform emotion analysis processing on the character string information, extract emotion information indicating an emotional state included in the character string information, and store the emotion information in association with the user characteristic information; to generate, based on the user characteristic information, the emotion information, and the structured information, a prompt sentence for instructing a generative AI model to execute a predetermined role and processing content, and input the prompt sentence into the generative AI model so as to cause the generative AI model to generate response information or assumed question information; to acquire operation screen information and guidance information relating to a new function or a new service, and include the operation screen information and the guidance information in the prompt sentence so as to cause the generative AI model to output the assumed question information indicating user questions and missing information relating to the new function or the new service; to generate improvement information and frequent question information for adding or modifying explanation information based on the assumed question information, and create guidance information including answer information corresponding to the frequent question information; to transmit the response information or the guidance information to an information processing terminal used by the user, and cause the information processing terminal to display the response information or the guidance information; and to store the prompt sentence, an output result of the generative AI model, and an operation history of the user, and update the emotion analysis processing and a generation process of the prompt sentence based on a storage result. This enables a technically improved interaction pipeline in which the server processor systematically integrates linguistic analysis, user attributes, and emotion information into dynamically generated prompt sentences for a generative AI model, anticipates inquiries for new functions or services, pre-computes guidance and frequently asked questions, and adaptively refines emotion analysis and prompt generation logic based on logged prompts, model outputs, and user operation histories, thereby enhancing computational efficiency, response relevance, and robustness of the overall computer-implemented support system.

The term “inquiry information” refers to information representing a question, request, feedback, or other communication transmitted by a user to a system, and expressed in natural language as one or more character strings.

The term “character string information” refers to data representing text of inquiry information in a machine-readable sequence of characters, such as a sequence of symbols encoded in a character encoding scheme.

The term “language processing technique” refers to a computational technique for analyzing and processing natural language text, including at least one of tokenization, word segmentation, part-of-speech tagging, syntactic parsing, semantic analysis, and named entity recognition.

The term “word segmentation processing” refers to processing that divides character string information into units corresponding to words or tokens to facilitate subsequent linguistic or semantic analysis.

The term “syntactic analysis processing” refers to processing that determines a grammatical structure of a sentence represented by character string information, including identifying dependencies or phrase structures among tokens.

The term “structured information having a semantic structure” refers to information derived from character string information and organized into a data structure that explicitly represents relationships among linguistic elements, such as dependencies, entities, intents, or attributes, in a machine-usable format.

The term “identification information” refers to information that uniquely or semi-uniquely identifies a user within a system, such as an account identifier, a session identifier, or another identifier associated with the user.

The term “attribute information” refers to information indicating characteristics of a user associated with identification information, including at least one of demographic attributes, preference attributes, membership attributes, and usage attributes.

The term “past usage history information” refers to information representing prior interactions or activities of a user within a system, including at least one of past inquiries, content accesses, transactions, or feature usages.

The term “user characteristic information” refers to information that includes attribute information and past usage history information for a user and that represents a profile or behavior tendency of the user in a structured form.

The term “emotion analysis processing” refers to processing that estimates an emotional state of a user by analyzing character string information, using an algorithm that maps linguistic features to one or more emotion categories or scores.

The term “emotion information” refers to information indicating an estimated emotional state associated with character string information, including at least one of an emotion category label and a numerical score representing an intensity or polarity of the emotion.

The term “prompt sentence” refers to a sequence of characters or tokens that encodes instructions, context, or role specifications for a generative AI model and that conditions behavior of the generative AI model when generating an output.

The term “generative AI model” refers to a machine learning model configured to generate natural language or other data based on input data, including at least a model using a neural network architecture trained to predict a sequence of tokens conditioned on a prompt sentence.

The term “predetermined role” refers to a behavioral specification or persona assigned to a generative AI model through a prompt sentence, such as simulating a particular type of user, an assistant, or an expert in a specific domain.

The term “processing content” refers to a computational task requested from a generative AI model via a prompt sentence, including at least one of generating a response, generating assumed questions, summarizing content, or proposing improvements.

The term “response information” refers to information generated by a generative AI model in response to a prompt sentence and intended to be presented to a user as an answer, explanation, or suggestion.

The term “assumed question information” refers to information representing one or more questions that are predicted or hypothesized by a generative AI model as questions that a user may ask under certain conditions, including for a new function or a new service.

The term “operation screen information” refers to information representing a configuration, layout, or content of one or more user interface screens for operating a function or service, including textual descriptions, labels, and structural data of user interface elements.

The term “guidance information” refers to information explaining usage, behavior, or characteristics of a function or service, including at least one of manuals, help texts, instructions, and explanatory notes.

The term “new function or new service” refers to a function or service for which a system has limited or no historical inquiry information from users and that is being newly introduced or significantly updated.

The term “missing information” refers to information that is not explicitly described in operation screen information or guidance information but is inferred, based on assumed question information, to be necessary or useful to users.

The term “improvement information” refers to information indicating modifications, additions, or reorganizations to be applied to explanation information, guidance information, or operation screen information to better address user needs or predicted inquiries.

The term “frequent question information” refers to assumed question information or actual question information that appears with a relatively high frequency or relevance and is selected as representative questions for documentation or guidance purposes.

The term “answer information” refers to information that is generated or specified as a reply to frequent question information and that is intended to resolve or clarify the content of the frequent question information.

The term “information processing terminal” refers to an electronic apparatus operated by a user that is capable of communicating with a server and presenting information, including at least one of a personal computer, a mobile device, a wearable device, or a dedicated terminal.

The term “operation history of the user” refers to information representing sequences of actions taken by a user within a system, including at least one of inputs, selections, navigations, and response confirmations executed by the user over time.

The term “output result of the generative AI model” refers to data generated by a generative AI model in response to a prompt sentence, including at least one of natural language text, structured data, and control directives.

The term “storage result” refers to a state or content of data stored in a storage apparatus or database, including stored prompt sentences, stored output results of the generative AI model, and stored operation histories of users.

The term “emotion analysis processing update” refers to modification or retraining of an algorithm for emotion analysis processing based on a storage result, in order to improve accuracy or performance of emotion information extraction.

The term “generation process of the prompt sentence” refers to a sequence of computational operations that construct a prompt sentence from structured information, user characteristic information, emotion information, operation screen information, guidance information, or other context data.

In one embodiment, a server, a terminal, and a user cooperate to implement the claimed system. The server includes at least one processor, a main memory, a non-volatile storage device, and a network interface. The server is implemented, for example, on a general-purpose computing platform such as a rack-mounted computer, a virtual machine, or a container instance in a cloud computing environment. The terminal is implemented as a general information processing device such as a personal computer, a smartphone, or a tablet, equipped with a display, an input device, a communication interface, and optionally a camera and a microphone. The user operates the terminal to transmit inquiry information and to view response information and guidance information.

The server executes program modules stored in the non-volatile storage device and loaded into the main memory. The program modules include a natural language processing module, an emotion analysis module, a user profile management module, a prompt generation module, a generative inference module, a guide and screen ingestion module, a question prediction and FAQ generation module, a logging and learning module, and a communication module. The server uses a general-purpose operating system and a runtime environment capable of executing software libraries for natural language processing and machine learning. The server uses, for example, a programming language environment that supports libraries such as a statistical language analysis library, a neural network library (such as a tensor-based computation framework), and an HTTP server framework.

The terminal executes a client-side application or web browser that communicates with the server via a communication network. The terminal presents a user interface that allows the user to enter inquiry information in the form of text and, in some embodiments, speech, and to trigger operations relating to new functions or new services. The terminal presents response information and guidance information received from the server as text, icons, and structured layouts. In some embodiments, the terminal presents augmented-reality overlays or smart glasses displays to store clerks in a physical store.

The server acquires inquiry information transmitted from the user through the terminal. The server receives the inquiry information as one or more natural language sentences over a network connection using the communication module. The server represents the inquiry information as character string information in a predefined character encoding. The server stores the character string information together with identification information of the user in a storage device, such as a relational database management system or a document-oriented data store. The server thereby creates a persistent record of the inquiry for subsequent processing and learning.

The server uses the natural language processing module to convert the character string information into structured information having a semantic structure. The server performs word segmentation processing by using, for example, a tokenization function provided by a language analysis library. The server performs syntactic analysis processing using a syntactic parser that computes, for each sentence, part-of-speech tags, dependency relations, and phrase boundaries. The server maps the syntactic structures into a structured representation, such as a graph or a tree, stored in a machine-usable format (for example, a graph data structure or a set of key-value pairs). The server extracts entities, predicates, and argument structures. The server stores the structured information in association with the inquiry record.

The server uses the user profile management module to acquire attribute information and past usage history information associated with the identification information. The server accesses a user profile database that stores attributes such as age group, region, membership tier, interest categories, and application usage statistics. The server accesses a usage history database that stores previous queries, clicked contents, purchased items, and interaction counts. The server aggregates the attribute information and the past usage history information into user characteristic information. The user characteristic information is represented, in one example, as a feature vector that includes numerical encodings of demographic attributes, categorical encodings of interest tags, and dense embeddings representing usage patterns derived from historical sequences.

The server uses the emotion analysis module to perform emotion analysis processing on the character string information. The server first transforms the character string information into feature vectors by using, for example, a word embedding model, a subword embedding model, or a contextual embedding model. The server inputs the feature vectors into a neural network architecture dedicated to emotion classification. In one implementation, the server uses a bidirectional recurrent neural network, a convolutional neural network, or a transformer-based classifier having multiple layers, attention mechanisms, and a final output layer that produces scores for emotion categories such as “joy,” “anger,” “sadness,” “fear,” and “surprise.” The server computes a loss function such as cross-entropy during training and updates model weights using an optimization algorithm such as stochastic gradient descent or an adaptive learning rate method. At inference time, the server outputs emotion information in the form of probability scores or real-valued intensities for the emotion categories and, in some cases, an aggregated polarity score. The server stores the emotion information in association with the user characteristic information and the inquiry record.

The server uses the prompt generation module to generate a prompt sentence for instructing a generative AI model. The generative AI model is, for example, a transformer-based autoregressive language model that is pre-trained on a large corpus of text data and optionally fine-tuned on domain-specific data. The server does not treat the generative AI model as a black box, but instead constructs prompt sentences that encode explicit constraints, persona roles, and input context, thereby enabling deterministic and reproducible behavior. The server composes the prompt sentence using the structured information, the user characteristic information, and the emotion information. The server includes, for example, descriptions of user attributes, past usage, detected emotion, and the semantic content of the inquiry.

In one example, the server generates a prompt sentence as follows:
“You are a support assistant interacting with a user.
User profile: age 20 s, gender female, interests: fashion, past purchases: brand A, brand B.
User emotion: anger=0.85, sadness=0.60.
User inquiry: ‘I am confused about the new one-click purchase feature and frustrated because my order has not arrived.’
Read the following guide for the one-click purchase feature and generate an empathetic and clear explanation that resolves the confusion and proposes concrete next steps for tracking or canceling the order.
[GUIDE_TEXT]”

The server encodes the prompt sentence as a sequence of tokens and transmits the sequence to the generative AI model via an inference API. The generative AI model processes the prompt sentence through multiple transformer layers, each performing self-attention and feed-forward transformations. The generative AI model computes, for each token position, a probability distribution over next tokens and generates a sequence of output tokens using a decoding strategy such as greedy decoding or beam search with a temperature parameter to control diversity.

The server uses the generative inference module to receive response information or assumed question information produced by the generative AI model. The server decodes the output tokens into text and applies post-processing, such as normalization, removal of disallowed phrases, and enforcement of style guidelines. The server thereby generates response information intended for immediate display to the user, or assumed question information used for generating documentation and guidance.

The server uses the guide and screen ingestion module to acquire operation screen information and guidance information relating to a new function or a new service. The server obtains user interface screen descriptions in digital document formats such as markup documents, drawing descriptions, or image files. The server converts image-based screens into text descriptions by using an optical character recognition engine and an object detection component that recognizes input fields, buttons, and labels. The server parses markup documents to extract hierarchical structures of interface components. The server acquires guidance information in the form of manuals, tooltips, and help files and converts them into a canonical text representation. The server stores the operation screen information and the guidance information in a screen repository.

The server constructs an extended prompt sentence that includes the operation screen information and the guidance information. In one example, the server generates a prompt sentence as follows:
“Read the following user interface description and guide for the new ‘one-click purchase’ function.
Act as a cautious user who has never used this function before.
List all questions you would naturally ask, especially regarding cancellation, payment methods, security, and error cases.
User interface:
[UI_TEXT]
Guide:
[GUIDE_TEXT]”

The server inputs this prompt sentence into the generative AI model and receives assumed question information. The assumed question information includes a list of predicted user questions such as “How can I cancel a one-click purchase?” and “What payment methods are available for one-click purchase?” The server stores the assumed question information in an assumed question database.

The server uses the question prediction and FAQ generation module to generate improvement information and frequent question information. The server analyzes the assumed question information by applying clustering algorithms or frequency counting to identify questions that are likely to appear frequently. The server regards such questions as frequent question information. The server also detects gaps between the existing guidance information and the assumed question information. When certain topics are not sufficiently covered in the guidance information, the server generates improvement information that specifies additional explanations or rearrangements of sections.

The server generates a further prompt sentence instructing the generative AI model to create answer information corresponding to the frequent question information. In one example, the server generates a prompt sentence as follows:
“Based on the following guide and interface description, generate an FAQ list.
For each question below, produce a concise and accurate answer that a user can understand without additional context.
Questions:
[LIST_OF_PREDICTED_QUESTIONS]
Guide:
[GUIDE_TEXT]”

The server inputs the prompt sentence into the generative AI model, receives answer information, and constructs FAQ entries pairing the frequent question information with the answer information. The server stores the FAQ entries as part of the guidance information for the new function or the new service.

The server uses the communication module to transmit the response information and the guidance information to the terminal. The server packages the response information and the guidance information into a structured message including text content and layout hints. The server transmits the message through a network protocol such as HTTP. The terminal receives the message and renders the response information within a chat interface or a help screen. The terminal displays the guidance information as a list of FAQ items, expandable sections, or contextual tooltips.

The terminal, when operated in a physical store, presents guidance information and response information to a store clerk wearing a smart device. The server may transmit, for example, a short phrase advising the clerk on how to greet a customer and which products to recommend. The terminal displays this information on a small screen or on an optical see-through display. This configuration provides a concrete machine control effect in which the pattern of information displayed to the clerk is adjusted in real time based on computed user characteristics and emotion information.

The server uses the logging and learning module to store prompt sentences, output results of the generative AI model, and operation histories of the users. The server maintains a log database in which each record includes a reference to the inquiry, the user characteristic information, the emotion information, the prompt sentence, the generated output, and subsequent user actions such as message acknowledgments, clicks on FAQ items, and navigation events. The server periodically extracts these logs to retrain or fine-tune the emotion analysis module and to improve the generation process of the prompt sentence.

The server, when updating the emotion analysis module, uses supervised learning techniques on the stored data. The server uses, for example, mini-batch training, in which feature vectors representing character string information are input to the emotion classifier, a loss function comparing predicted emotion labels with ground-truth labels is computed, and model weights are updated through backpropagation. The server may employ regularization techniques, data augmentation strategies, and early stopping criteria to prevent overfitting and to improve generalization. By using a larger and more diverse set of stored inquiries, the server reduces the error rate of emotion detection and thereby improves the accuracy of adaptive response generation.

The server, when updating the generation process of the prompt sentence, applies rule-based modifications and statistical analysis to determine which prompt patterns result in higher user satisfaction and faster resolution. The server compares interaction metrics such as time-to-answer, resolution rate without human intervention, and the number of follow-up questions for different types of prompt sentences. The server then automatically adjusts the template composition rules, for instance by adding or removing sections related to emotion, by changing the order in which user profile elements are presented, or by introducing explicit instructions such as “If information is not in the guide, state that the information is unknown instead of guessing.” Because these modifications are derived from data-driven analysis rather than static manual design, the system improves computational efficiency and output quality over time.

The use of the generative AI model and the prompt sentence in the described architecture does not merely automate human drafting of answers. The server constructs structured representations of inquiries, user profiles, and emotions that are not directly available to a human operator without substantial manual analysis. The server then exploits these representations to control a high-dimensional generative model, guiding its internal attention and decoding dynamics. This combination leads to reduced token generation length, reduced number of inference calls, and higher precision of relevant content, thus reducing communication overhead between the server and the generative AI model and improving processing throughput.

Additionally, the server anticipates future inquiries for a new function or a new service before deployment, and precomputes guidance information and FAQ entries. This predictive behavior reduces the frequency of redundant similar inquiries that would otherwise need to be processed in real time, thereby reducing load on the server processor, memory, and network interface. The system uses specific data structures for assumed questions and for FAQ entries, allowing efficient indexing and retrieval during later user interactions.

The described system improves computer technology itself by providing a specialized, non-generic pipeline that integrates syntactic parsing, emotion classification, profile-based feature encoding, structured prompt sentence generation, and generative inference, all under programmatic feedback from stored logs. The server modifies the internal configuration of the emotion classifier and the prompt sentence generator based on observed behavior and performance metrics. As a result, the server reduces the average number of interaction rounds and the average length of model outputs needed to resolve a user inquiry, improves the precision of content selection, and reduces storage redundancy by consolidating frequently asked questions into canonical entries. These improvements are not merely business process changes but constitute specific enhancements to how computing resources are orchestrated in memory, on processing units, and over communication channels.

In an alternative embodiment, the server uses different neural network architectures for the generative AI model, such as an encoder-decoder transformer or a mixture-of-experts model, and different emotion classifiers, such as a convolutional neural network with max pooling. The server may represent structured information in a graph database rather than a relational database. The terminal may be implemented as a kiosk, a vehicle-mounted device, or an embedded panel in a home appliance. The core operations, however, remain the same: the server acquires inquiry information, converts it into structured information, associates it with user characteristic information and emotion information, generates and updates prompt sentences for a generative AI model, receives and post-processes generated outputs, anticipates future inquiries for new functions or services, and delivers context-aware guidance to the terminal in a technically efficient manner.

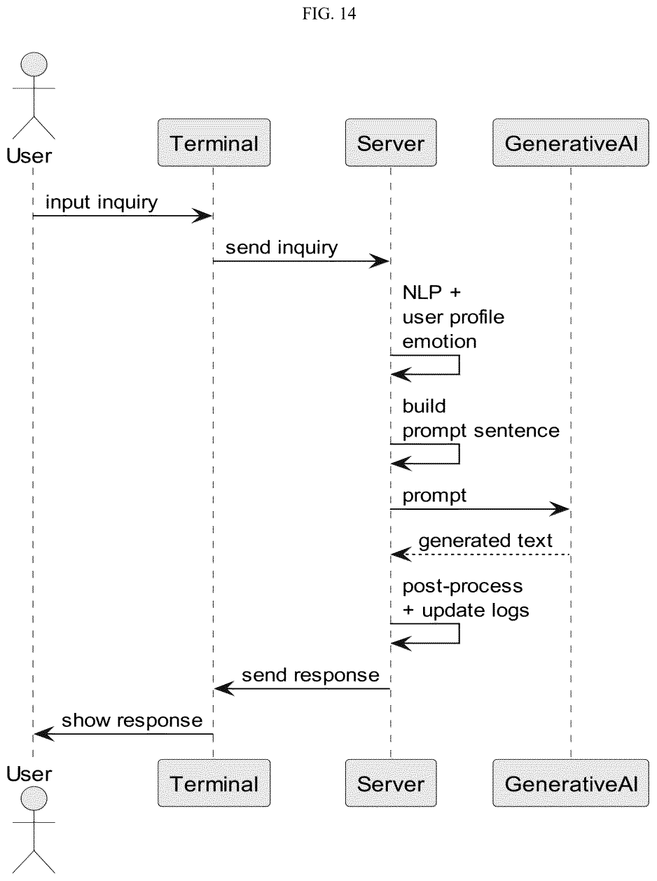

The following describes the processing flow using FIG. 14.

### Step 1:

The user inputs inquiry information on the terminal.

The user enters one or more sentences in natural language (for example, “I am confused about the new one-click purchase feature and my order has not arrived.”) into a chat window, form, or help dialog of an application running on the terminal.

The terminal receives the text input as a character string together with metadata such as a time stamp and a user identifier, and constructs a request object.

The terminal transmits the request object to the server via a network using a communication protocol such as HTTPS.

Input: user's natural language text, user identifier, and basic terminal metadata.

Output: a network request containing the inquiry information sent to the server.

### Step 2:

The server receives and stores the inquiry information.

The server accepts the network request through a communication module and parses the payload to extract the inquiry text, the user identifier, and the metadata.

The server converts the inquiry text into character string information in a standard encoding, and creates a new inquiry record in a storage device such as a relational database.

The server associates the inquiry record with the user identifier and stores fields such as original text, time stamp, communication channel, and request identifier.

Input: network request from the terminal containing the inquiry text and user identifier.

Output: a stored inquiry record including character string information and associated identifiers.

### Step 3:

The server generates structured information from the inquiry text by natural language processing.

The server applies word segmentation processing to the character string information, for example by tokenizing the text into word units using a language processing library.

The server performs syntactic analysis processing on the tokens, generating part-of-speech tags and dependency relations, and optionally identifying named entities and phrases.

The server converts the syntactic analysis results into structured information, such as a set of key-value pairs representing detected entities, intents, slots, and relations, or a labeled graph representing the sentence structure.

The server stores the structured information in association with the inquiry record.

Input: character string information from the inquiry record.

Output: structured information having a semantic structure derived from the inquiry text.

### Step 4:

The server acquires user characteristic information.

The server uses the user identifier linked to the inquiry record to query one or more profile databases.

The server retrieves attribute information such as age group, region, membership class, interest categories, and language preference, as well as past usage history information such as previous inquiries, clicked contents, and transaction summaries.

The server aggregates these data into user characteristic information, for example by forming a feature vector that encodes categorical attributes, numerical statistics, and behavior embeddings.

The server stores the user characteristic information in association with the inquiry record.

Input: user identifier from the inquiry record.

Output: user characteristic information including attribute information and past usage history information.

### Step 5:

The server performs emotion analysis processing on the inquiry text.

The server converts the character string information into numerical feature representations, for example by mapping tokens to embeddings and forming a sequence vector.

The server inputs the feature representations into an emotion classification model implemented by a neural network such as a recurrent network, a convolutional network, or a transformer classifier.

The server calculates emotion scores for one or more emotion categories, for example joy, anger, sadness, and fear, and optionally computes a polarity score.

The server outputs emotion information including category labels and intensity values, and stores the emotion information in association with the user characteristic information and the inquiry record.

Input: character string information of the inquiry.

Output: emotion information indicating an estimated emotional state corresponding to the inquiry.

### Step 6:

The server acquires operation screen information and guidance information for a relevant function or service.

The server determines, from the structured information and the inquiry content, a target function or service (for example, a new one-click purchase function).

The server retrieves operation screen information such as layouts, element descriptions, and control flows from a screen repository, and retrieves guidance information such as manuals, help texts, and FAQ drafts from a documentation repository.

The server normalizes these data into text form, for example by extracting text from markup, performing basic cleaning, and concatenating related sections.

Input: structured information of the inquiry and an identifier of the function or service.

Output: operation screen information and guidance information in a text-based representation.

### Step 7:

The server generates a prompt sentence for a generative AI model.

The server composes a text template that includes user characteristic information, emotion information, structured information representing the inquiry, and, when applicable, the operation screen information and the guidance information.

The server fills the template with concrete values to form a prompt sentence that instructs the generative AI model about a role to simulate and a processing content to perform.

For direct answering, the server generates, for example, a prompt sentence such as:
“You are a support assistant interacting with a user.
User profile: age 20 s, gender female, interests: fashion, past purchases: brand A, brand B.
User emotion: anger=0.85, sadness=0.60.
User inquiry: ‘I am confused about the new one-click purchase feature and frustrated because my order has not arrived.’
Read the following guide for the one-click purchase feature and generate an empathetic and clear explanation that resolves the confusion and proposes concrete next steps for tracking or canceling the order.
[GUIDE_TEXT]”

For question prediction, the server generates, for example, a prompt sentence such as: “Read the following user interface description and guide for the new ‘one-click purchase’ function.

Act as a cautious user who has never used this function before.

List all questions you would naturally ask, especially regarding cancellation, payment methods, security, and error cases.
User interface:
[UI_TEXT]
Guide:
[GUIDE_TEXT]”

Input: user characteristic information, emotion information, structured information, and optionally operation screen and guidance information.

Output: a prompt sentence that encodes instructions and context for the generative AI model.

### Step 8:

The server inputs the prompt sentence into the generative AI model and receives generated text.

The server transmits the prompt sentence to the generative AI model through an inference interface, converting the prompt sentence into a token sequence compatible with the model.

The generative AI model executes multiple layers of attention and transformation on the token sequence and generates output tokens that form response information or assumed question information.

The server collects the output tokens, decodes them into text, and joins the text segments into complete sentences or lists.

The server stores the generated text together with references to the corresponding prompt sentence and inquiry record.

Input: prompt sentence generated by the server.

Output: generated text in the form of response information or assumed question information from the generative AI model.

### Step 9:

The server post-processes the generated text and constructs guidance information or direct responses.

The server examines the generated text to remove or replace prohibited or irrelevant segments according to predefined rules.

When the generated text represents assumed question information, the server analyzes it to identify frequent question information, for example by counting similar questions and clustering them.

The server optionally generates an additional prompt sentence that asks the generative AI model to produce answer information for the frequent question information, and processes the resulting outputs as FAQ entries.

The server aggregates the questions and answers with existing documentation to form updated guidance information.

When the generated text represents a direct answer, the server formats it as response information that can be presented to the user.

Input: generated text from the generative AI model.

Output: cleaned and structured response information and/or updated guidance information, including FAQ entries.

### Step 10:

The server transmits response information and guidance information to the terminal.

The server encapsulates the response information and any relevant guidance information into a response object, which may include layout hints such as title, message body, and optional FAQ list.

The server sends the response object to the terminal through the communication module using a network protocol.

The terminal receives the response object and parses the content for display.

Input: response information and guidance information prepared by the server.

Output: a network response from the server to the terminal containing display-ready data.

### Step 11:

The terminal displays the response information and guidance information to the user.

The terminal renders the main answer as text in a chat bubble, dialog, or dedicated support screen and shows related guidance information such as FAQ items, links, and buttons to perform actions (for example, “Track order” or “Cancel one-click purchase”).

The terminal updates the user interface according to layout hints, for example by highlighting important recommendations when the emotion information indicates a strong negative emotion.

The user views the displayed information and may perform follow-up actions such as asking further questions, selecting an FAQ, or executing suggested operations.

Input: response object from the server containing response information and guidance information.

Output: visual and interactive user interface components presented to the user, and new user interactions that can be captured for subsequent processing.

### Step 12:

The server logs prompt sentences, model outputs, and user operation history, and updates internal models and prompt generation logic.

The server records each prompt sentence, the corresponding generative AI model output, and subsequent user interactions such as additional inquiries, clicks, or confirmations in a log storage.

The server uses the logged data as training or fine-tuning data for the emotion analysis model, updating model weights based on error signals between predicted emotion labels and derived ground truth or proxy labels.

The server analyzes correlations between prompt sentence structures and performance indicators such as resolution rate and number of follow-up questions, and adjusts the rules or parameters used to compose future prompt sentences.

By executing these data processing and learning operations, the server improves the accuracy of emotion detection and the effectiveness of prompt sentences over time, and thereby enhances the quality and efficiency of future responses.

Input: stored prompt sentences, generated outputs, and user operation history.

Output: updated parameters of emotion analysis and prompt generation modules, and improved processing behavior for subsequent inquiries.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

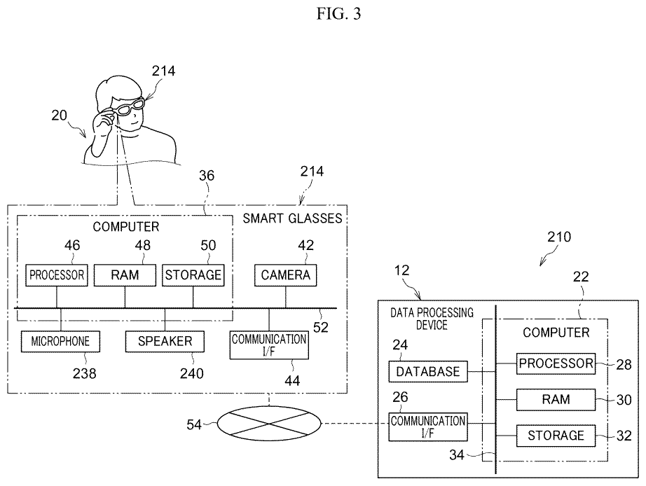

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

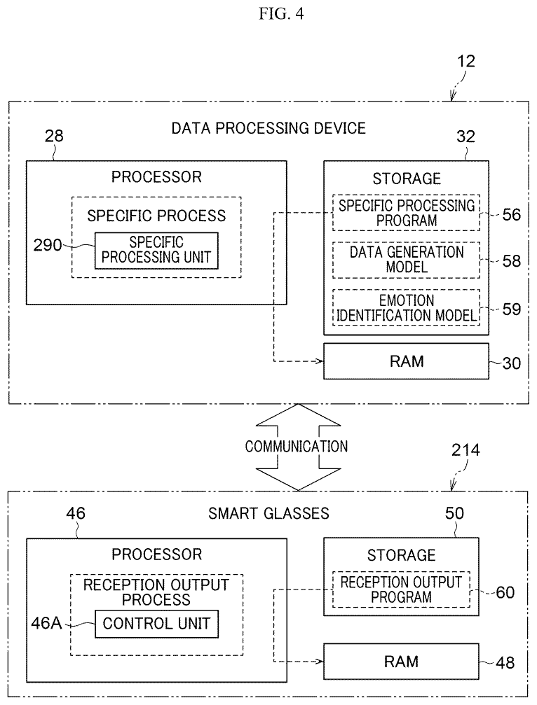

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

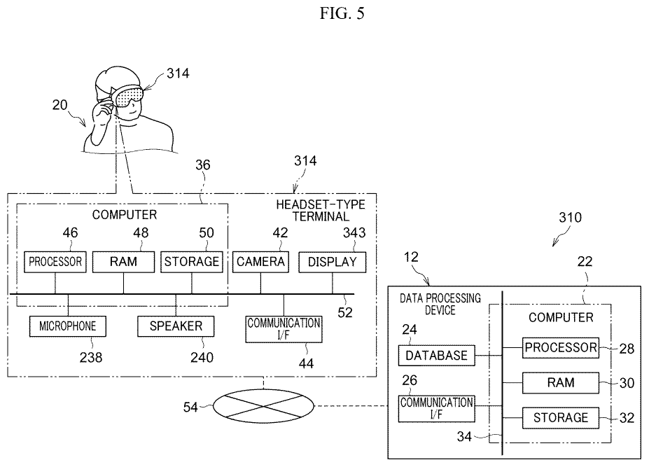

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

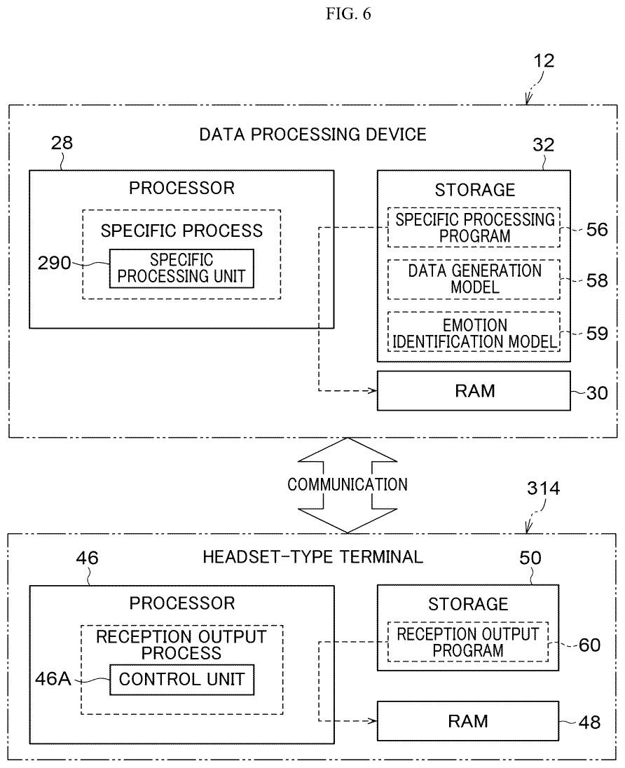

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

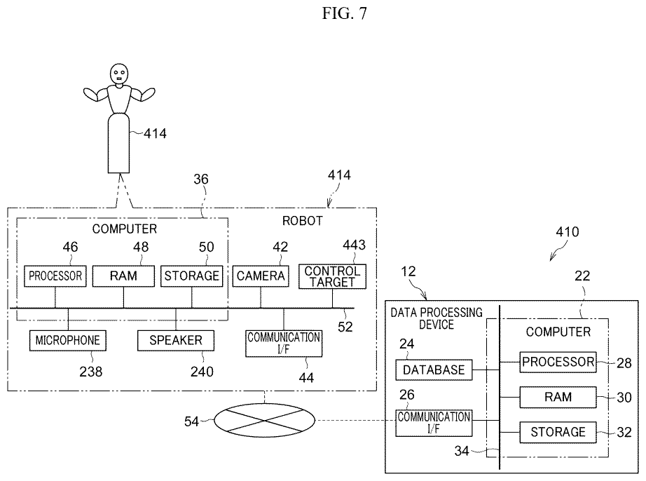

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

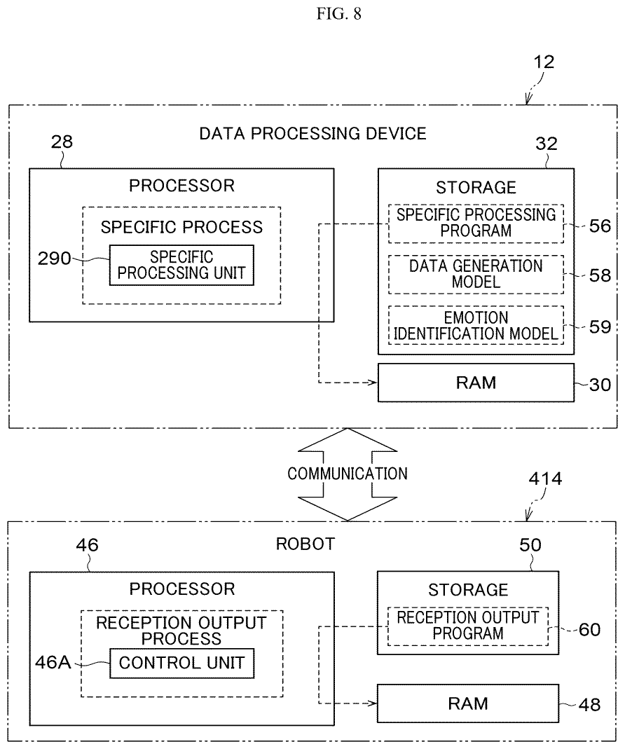

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

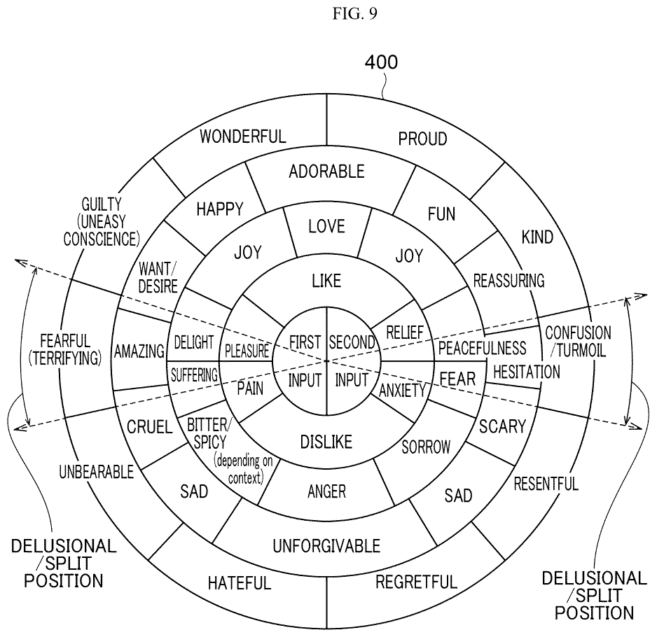

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

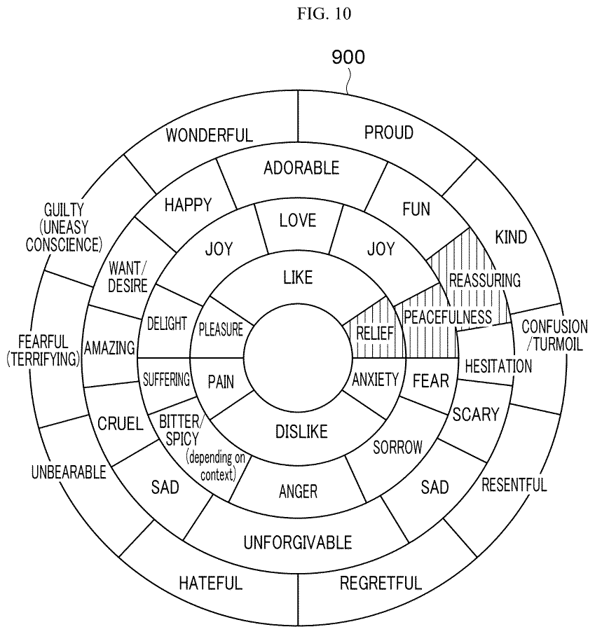

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor and a storage device,
wherein the processor is configured to
acquire inquiry content transmitted from a user via a communication terminal as text data, and store the text data in the storage device,
perform natural language processing on the text data stored in the storage device by executing morphological analysis and syntactic analysis as preprocessing, including segmenting phrases, assigning parts of speech, removing unnecessary terms, and normalizing word forms, and convert the text data into structured data,
apply a statistical learning algorithm or a machine learning algorithm to the structured data to calculate semantic feature values and, based on the semantic feature values, identify an intent class corresponding to the inquiry content and a group of highly relevant terms,
store, as analysis results, the intent class, the group of highly relevant terms, and an original text of the inquiry content as training data in the storage device, and register the training data in a format usable for learning or performance improvement of a generative AI model,
generate, based on the analysis results, a prompt sentence that instructs execution conditions and a response policy to the generative AI model, and input the prompt sentence and the inquiry content into the generative AI model to cause the generative AI model to generate a natural language response corresponding to the inquiry content, and
perform post-processing on the natural language response obtained from the generative AI model, the post-processing including content checking and format adjustment, generate a text message of the natural language response in a format transmittable to the communication terminal, and transmit the text message to the communication terminal.

### (Supplementary 2)

The system according to supplementary 1,
wherein the processor is configured to
associate the semantic feature values and the intent class identified as the analysis results with historical response data relating to the inquiry content, store the historical response data in the storage device, periodically extract the historical response data as training data for learning or fine-tuning of the generative AI model, and update parameters of the generative AI model to improve accuracy of the natural language response for future inquiry content.

### (Supplementary 3)

The system according to supplementary 1,
wherein the processor is configured to
integrate a plurality of information elements including the intent class, the group of highly relevant terms, the original text of the inquiry content, and constraint conditions for response generation when generating the prompt sentence, and generate a structured prompt sentence that guides the generative AI model to generate the natural language response adapted to the inquiry content.

### Application Example 1

### (Supplementary 1)

A system comprising a processor,
wherein the processor is configured to
receive, from a terminal of a user via a communication network, text information including an inquiry from the user, and acquire the text information as electronic data together with additional information including a request item and identification information,
perform, on the acquired text information, natural language processing using a language processing program to execute word segmentation, removal of unnecessary words,
normalization of word forms, assignment of parts of speech, semantic analysis, and
normalization of expressions, and convert the inquiry into structured data including intent information, important word information, and target information,
determine, based on the structured data, a classification result of the inquiry and presence or absence of missing information, and determine a type of additional information required for resolution of the inquiry,
generate, based on the structured data and the type of the additional information, a prompt sentence for instructing a conversational information processing model to generate a natural language response, by combining the inquiry and metadata with template information stored in advance,
transmit the generated prompt sentence to an external generative AI model using a communication protocol, and acquire a response text in natural language from the external generative AI model,
perform, on the acquired response text, content inspection, length adjustment, conversion of expression format, and insertion of additional information to thereby generate a user-oriented response message, and transmit the user-oriented response message in real time to the terminal of the user,
receive, from the terminal of the user, feedback information including evaluation information and comment information regarding the response message, and store the feedback information in association with the inquiry, the prompt sentence, and the response text, and aggregate and analyze the stored feedback information, and update the template information and generation conditions of the prompt sentence based on an analysis result, thereby automatically adjusting a configuration of a subsequent prompt sentence and usage conditions of the generative AI model.

### (Supplementary 2)

The system according to supplementary 1,
wherein the processor is configured to
update, based on the structured data and the feedback information, a classification rule of the inquiry and a parameter of an identification model for intent estimation, and dynamically change, using an updated classification result, instruction content and required conditions to be included in the prompt sentence.

### (Supplementary 3)

The system according to supplementary 1,
wherein the processor is configured to
accumulate the feedback information as a group of learning data, and periodically optimize, based on the group of learning data, an expression pattern of the template information, an input format to the generative AI model, and a presentation format of the response message.

### Example 2

### (Supplementary 1)

A system comprising a processor,
wherein the processor is configured to
acquire, from a storage device, attribute information related to a user based on identification information of the user,
perform preprocessing on the acquired attribute information by using a general-purpose program and a data processing program executed on an information processing apparatus, the preprocessing including numerical conversion processing and encoding processing, so as to convert the acquired attribute information into preprocessed data suitable as input to a generative AI model,
generate, based on the preprocessed data, a natural language description reflecting attributes including an age category, a gender category, and a usage history category, add to the natural language description conditions regarding imitation or reproduction of user behavior and conditions regarding an output format, and generate a prompt sentence for input to the generative AI model,
input, via a communication path, the prompt sentence to the generative AI model, cause the generative AI model to generate, based on the prompt sentence, a natural language text representing a user behavior pattern, and obtain a generation result, and
convert the obtained natural language text into display data and transmit the display data, via the communication path, to a terminal device including a display device.

### (Supplementary 2)

The system according to supplementary 1,
wherein the processor is configured to
derive an age layer from age information included in the attribute information, derive a gender expression from gender information included in the attribute information, extract category information indicating fields of interest or purchase tendencies from usage history information included in the attribute information, and automatically generate a natural language expression obtained by combining the age layer, the gender expression, and the category information, and include the natural language expression in the prompt sentence.

### (Supplementary 3)

The system according to supplementary 1,
wherein the processor is configured to
add, to the prompt sentence, conditions specifying at least one of a period of the user behavior, a level of detail of the user behavior, and an output structure, input the prompt sentence with the conditions to the generative AI model, and cause the generative AI model to generate, as the natural language text, a user behavior scenario described in at least one of a time series format and an itemized format in accordance with the conditions.

### Application Example 2

### (Supplementary 1)

A system comprising a processor,
wherein the processor is configured to
acquire inquiry information transmitted from a user, acquire the inquiry information as character string information by using a language processing technique, and convert the character string information into structured information having a semantic structure by performing word segmentation processing and syntactic analysis processing on the character string information,
acquire, based on the structured information and identification information for identifying the user, attribute information and past usage history information associated with the identification information, and generate user characteristic information including the attribute information and the usage history information,
perform emotion analysis processing on the character string information, extract emotion information indicating an emotional state included in the character string information, and
store the emotion information in association with the user characteristic information, generate, based on the user characteristic information, the emotion information, and the structured information, a prompt sentence for instructing a generative AI model to execute a predetermined role and processing content, and input the prompt sentence into the generative AI model so as to cause the generative AI model to generate response information or assumed question information,
acquire operation screen information and guidance information relating to a new function or a new service, and include the operation screen information and the guidance information in the prompt sentence so as to cause the generative AI model to output the assumed question information indicating user questions and missing information relating to the new function or the new service,
generate improvement information and frequent question information for adding or modifying explanation information based on the assumed question information, and create guidance information including answer information corresponding to the frequent question information,
transmit the response information or the guidance information to an information processing terminal used by the user, and cause the information processing terminal to display the response information or the guidance information, and
store the prompt sentence, an output result of the generative AI model, and an operation history of the user, and update the emotion analysis processing and a generation process of the prompt sentence based on a storage result.

### (Supplementary 2)

The system according to supplementary 1,
wherein the processor is configured to
generate the prompt sentence for inputting the operation screen information and the guidance information relating to the new function or the new service into the generative AI model, cause the generative AI model to virtually reproduce a plurality of types of the user characteristic information, and output the assumed question information according to each of the plurality of types of the user characteristic information so as to predict future occurrence of inquiries relating to the new function or the new service.

### (Supplementary 3)

The system according to supplementary 1,
wherein the processor is configured to
switch an expression of the prompt sentence and an expression of the response information based on the emotion information, and, when a negative emotion included in the emotion information is equal to or greater than a predetermined threshold, control the generative AI model so as to generate the response information including an apology expression or a problem solving proposal.

What is claimed is:

1. A system comprising:
circuitry configured to
acquire, via a communication interface coupled to a packet-switched network, text data transmitted from a terminal device, and store the text data in a storage device,
perform multi-stage linguistic processing on the text data, the multi-stage linguistic processing comprising tokenization, syntactic dependency analysis, token-attribute assignment, filtering of low-contribution tokens, and normalization of token forms, to convert the text data into structured data organized according to a predefined schema,
apply a trained computational model to the structured data to compute semantic feature values comprising numerical vector representations encoding contextual relationships among tokens, and identify, based on the semantic feature values, an intent class and a group of relevant terms associated with the text data,
store, in the storage device, the intent class, the group of relevant terms, and the text data as training data in a format usable for parameter updating of a generative neural network model,
generate, based on the intent class, the group of relevant terms, the text data, and constraint conditions, a structured prompt data structure that integrates the intent class, the group of relevant terms, and the constraint conditions into a template format, and input the structured prompt data structure into the generative neural network model to cause the generative neural network model to generate a natural language output, and
perform post-processing on the natural language output, the post-processing comprising content verification and format adjustment, and transmit, via the communication interface, the post-processed natural language output to the terminal device.

2. The system according to claim 1, wherein the circuitry is further configured to periodically extract the training data stored in the storage device and update parameters of the generative neural network model based on the training data by computing a loss value between generated token distributions and target tokens and performing gradient-based optimization.

3. The system according to claim 2, wherein the circuitry is further configured to associate the semantic feature values and the intent class with historical output data, and store the historical output data in the storage device as additional training data for iterative refinement of the generative neural network model.

4. The system according to claim 3, wherein the circuitry is further configured to receive, via the communication interface, feedback data from the terminal device, store the feedback data in association with the text data, the structured prompt data structure, and the natural language output, aggregate and analyze the stored feedback data, and update at least one of the template format, a generation condition for the structured prompt data structure, a classification rule for the intent class, and a parameter of an identification model for intent estimation.

5. The system according to claim 4, wherein the circuitry is further configured to compute correlations between instruction phrases in the structured prompt data structure and feedback quality metrics derived from the feedback data, and adjust selection priority of template variants based on the computed correlations.

6. The system according to claim 5, wherein the circuitry is further configured to construct training examples by pairing feature vectors derived from the structured data with ground-truth signals derived from the feedback data, and perform fine-tuning of the identification model by minimizing an error function through gradient-based weight adjustment.

7. The system according to claim 1, wherein the trained computational model comprises a neural network-based embedding model that maps tokenized and normalized text sequences to fixed-dimensional embedding vectors, and a classifier model that receives the embedding vectors and computes a probability distribution over a set of intent classes.

8. The system according to claim 7, wherein the circuitry is further configured to identify the group of relevant terms by combining syntactic structure information from the syntactic dependency analysis with feature importance measures derived from the classifier model, the feature importance measures comprising at least one of attention weights and gradient-based importance scores.

9. The system according to claim 8, wherein the structured prompt data structure comprises explicit tags designating the intent class, the group of relevant terms, and an instruction section specifying the constraint conditions, arranged in a predefined sequential format that reduces ambiguity at an input stage of the generative neural network model.

10. The system according to claim 9, wherein the constraint conditions comprise at least one of a maximum output length, a mandatory inclusion condition for specified information, and an adherence requirement to a predetermined response policy.

11. The system according to claim 1, wherein the post-processing comprises applying at least one of a rule-based filter and an auxiliary classifier model to detect prohibited expressions or inconsistencies in the natural language output, and modifying or truncating the natural language output based on detection results.

12. The system according to claim 11, wherein the circuitry is further configured to reformat the natural language output into a presentation format selected based on a device type of the terminal device, the presentation format comprising at least one of a numbered-step format, a sectioned paragraph format, and an itemized list format.

13. The system according to claim 12, wherein the circuitry is further configured to insert supplemental reference data comprising at least one of a hyperlink and an identifier corresponding to stored knowledge base entries into the reformatted natural language output.

14. The system according to claim 1, wherein the circuitry is further configured to acquire, from the storage device, attribute data associated with an identifier of a source of the text data, the attribute data comprising at least an age category value, a category classification value, and a usage history vector, perform numerical conversion processing and encoding processing on the attribute data to generate preprocessed attribute data, and include a natural language description derived from the preprocessed attribute data in the structured prompt data structure.

15. The system according to claim 14, wherein the circuitry is further configured to perform emotion analysis processing on the text data using an emotion classification neural network model to extract emotion information comprising probability scores for a plurality of emotion categories, store the emotion information in association with the attribute data, and include the emotion information in the structured prompt data structure so as to condition behavior of the generative neural network model based on an estimated emotional state.

16. The system according to claim 1, wherein the circuitry is further configured to acquire operation screen data and guidance data relating to a function, include the operation screen data and the guidance data in an extended prompt data structure, input the extended prompt data structure into the generative neural network model to cause the generative neural network model to generate predicted inquiry data indicating anticipated questions and missing information relating to the function, and generate supplemental documentation data comprising answer data corresponding to the predicted inquiry data.

17. The system according to claim 16, wherein the circuitry is further configured to analyze the predicted inquiry data by applying clustering to identify frequently occurring question patterns, generate improvement data specifying additions or modifications to the guidance data based on the frequently occurring question patterns, and store the improvement data and the supplemental documentation data in the storage device.

18. A system comprising:
circuitry configured to
acquire, via a communication interface coupled to a packet-switched network, text data transmitted from a terminal device, and store the text data in a storage device,
perform multi-stage linguistic processing on the text data comprising tokenization, syntactic dependency analysis to generate a dependency graph, token-attribute assignment including part-of-speech tagging, filtering of low-contribution tokens based on a predefined stop-token list, and normalization of token forms including lemmatization, to convert the text data into structured data,
compute, using a transformer-based embedding model comprising multiple encoder layers with self-attention mechanisms, semantic feature values as fixed-dimensional embedding vectors encoding contextual relationships among tokens in the structured data,
apply a classifier model to the semantic feature values to compute a probability distribution over a set of intent classes, select an intent class with a highest probability, and identify a group of relevant terms by combining syntactic dependency information with feature importance measures from the classifier model,
store the intent class, the group of relevant terms, and the text data in the storage device as training data,
construct a structured prompt data structure by integrating the intent class, the group of relevant terms, the text data, and constraint conditions into a template data structure, and input the structured prompt data structure into a generative neural network model to generate a natural language output, and
perform post-processing on the natural language output comprising content verification using a filter model, format adjustment, and supplemental reference insertion, and transmit the post-processed natural language output via the communication interface to the terminal device.

19. The system according to claim 18, wherein the circuitry is further configured to receive feedback data from the terminal device, store the feedback data in association with the text data, the structured prompt data structure, and the natural language output, aggregate and analyze the feedback data, and update at least one of the template data structure, generation conditions for the structured prompt data structure, and parameters of the classifier model based on an analysis result.

20. A method comprising:
acquiring, via a communication interface coupled to a packet-switched network, text data transmitted from a terminal device, and storing the text data in a storage device;
performing multi-stage linguistic processing on the text data, the multi-stage linguistic processing comprising tokenization, syntactic dependency analysis, token-attribute assignment, filtering of low-contribution tokens, and normalization of token forms, to convert the text data into structured data organized according to a predefined schema;
applying a trained computational model to the structured data to compute semantic feature values comprising numerical vector representations encoding contextual relationships among tokens, and identifying, based on the semantic feature values, an intent class and a group of relevant terms associated with the text data;
storing, in the storage device, the intent class, the group of relevant terms, and the text data as training data in a format usable for parameter updating of a generative neural network model;
generating, based on the intent class, the group of relevant terms, the text data, and constraint conditions, a structured prompt data structure that integrates the intent class, the group of relevant terms, and the constraint conditions into a template format, and inputting the structured prompt data structure into the generative neural network model to cause the generative neural network model to generate a natural language output; and
performing post-processing on the natural language output, the post-processing comprising content verification and format adjustment, and transmitting, via the communication interface, the post-processed natural language output to the terminal device.
